(19) United States
(12) Patent Application Publication
(10) Pub. No.: US 2025/0165221 A1
(43) Pub. Date: May 22, 2025

(54) QUANTUM CONTROL SYSTEM ARCHITECTURE FOR REAL-TIME PAULI TWIRLING OF QUANTUM PROGRAMS

(71) Applicant: International Business Machines Corporation, Armonk, NY (US)

(72) Inventors: Thomas Alexander, Halifax (CA); Ian Hincks, Waterlo (CA); Michael B. Healy, Cortlandt Manor, NY (US); Scott M. Willenborg, Stewartville, MN (US)

(21) Appl. No.: 18/514,200

(22) Filed: Nov. 20, 2023

(51) Int. Cl. G06F 7/58

(52) U.S. Cl. CPC G06F 7/582

(57) ABSTRACT

Systems, computer program products and/or computer-implemented methods described herein relate to a quantum control system architecture for real-time Pauli twirling of quantum programs. A system can include a memory that stores computer executable components and a processor that executes the computer executable components, which can include an initialization component that determines a seed to be applied to a first pseudorandom number generator (PRNG) associated with a first qubit of an input quantum circuit, the seed being shared with one or more second PRNGs associated with respective second qubits of the input quantum circuit that share a frame with the first qubit; and a Pauli twirling component that applies selected Clifford operations to the first qubit before and after execution of respective layers of the input quantum circuit, where the selected Clifford operations are selected according to an output of the first PRNG that is produced based on the seed.

### TECHNICAL FIELD

The present disclosure generally relates to a quantum control system architecture, and more particularly to a quantum control system architecture that provides real-time Pauli twirling of quantum programs.

### BACKGROUND

While quantum computing can be conceptualized at a high level in terms of quantum gates and measurements applied to qubits, control systems for generating quantum gates and producing measurements generally do not operate in terms of applying gates directly to qubits in the same sense as applying a classical logic gate. Instead, these control systems can control qubits using waveform stimuli and/or other stimuli that are emitted from hardware controllers.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to facilitate a quantum control system architecture for real-time Pauli twirling of quantum programs.

In accordance with an embodiment, a system can include a memory that stores computer executable components and a processor that executes the computer executable components stored in the memory. The computer executable components can include an initialization component that determines a seed to be applied to a first pseudorandom number generator (PRNG) associated with a first qubit of an input quantum circuit, the seed being shared with one or more second PRNGs associated with respective second qubits of the input quantum circuit that share a frame with the first qubit; and a Pauli twirling component that applies selected Clifford operations to the first qubit before and after execution of respective layers of the input quantum circuit, resulting in a twirled quantum circuit, where the selected Clifford operations are selected according to an output of the first PRNG that is produced based on the seed. Benefits of the system can include, e.g., improved quantum circuit error mitigation through the ability to dynamically generate Pauli twirled circuits in hardware within an executing quantum program that may contain control flow, as well as reduced messaging overhead associated with communicating parameters for Pauli twirling.

In embodiments, the initialization component can receive the seed in a control message from a control system prior to execution of the input quantum circuit, and the control message can cause the system to execute the input quantum circuit at an action time specified by the control message. These features can have the technical effect of, e.g., enabling the communication of a single seed value prior to execution of the circuit instead of a complete set of parameters for Pauli twirling, which can reduce the amount of information communicated during execution. Use of a control message in this manner can also have the benefit of ensuring precise timing control for operations associated with the input quantum circuit, resulting in improved inter-qubit synchronization.

In embodiments, the selected Clifford operations can be selected from a group including an identity gate, a Pauli-X gate, a Pauli-Y gate, and a Pauli-Z gate. This can have the technical effect of enabling the space of Clifford operations to be encoded using two-bit values, which can reduce the amount of information generated and/or utilized in connection with selecting an operation.

In embodiments, the computer executable components can further include a sampling component that samples values from the first PRNG; and a lookup component that selects the selected Clifford operations based on a defined mapping between the values and the selected Clifford operations. Similar to the above feature, this can have the technical effect of enabling a Clifford operation to be selected in a simplified manner using random data samples and a hardware enabled mapping function.

In embodiments, the computer executable components can further include a phase update component that modifies, at the respective layers of the input quantum circuit, a phase of the frame of the first qubit according to a function of the selected Clifford operations. Benefits of the phase update component can include, e.g., improved hardware efficiency associated with Pauli twirling by enabling the use of pre-computed phase updates instead of parameters that are computed individually for each operation.

In embodiments, the computer executable components can further include a decomposition component that defines a rotation of the first qubit via a series of quantum gates, where the phase update component can modify the phase of the frame of the first qubit by applying a phase rotation to at least one gate of the series of quantum gates. The decomposition component can have the technical effect of simplifying qubit phase updates via the ability to encode arbitrary phase updates using a uniform series of gates.

In embodiments, an amount of the phase rotation can be defined by an instruction provided to the system by a control system. This can have the technical effect of, e.g., simplifying a phase rotation into a special-purpose instruction that can be implemented efficiently in hardware.

In embodiments, the selected Clifford operations are first selected Clifford operations, the Pauli twirling component can apply the first selected Clifford operations to the first qubit before and after execution of respective layers of a first instance of the input quantum circuit, resulting in a first twirled quantum circuit, the output of the first PRNG can be a first output, and the Pauli twirling component can further apply second selected Clifford operations to the first qubit before and after execution of respective layers of a second instance of the input quantum circuit, resulting in a second twirled quantum circuit, the second selected Clifford operations being selected according to a second output of the first PRNG that is produced based on the seed and without reloading the input quantum circuit. These features can have the technical effect of, e.g., enabling Pauli twirling for multiple shots or instances of a given quantum circuit without requiring reloading or recompilation of the circuit.

In embodiments, the initialization component can derive the seed from a first clock signal associated with the first PRNG, the first clock signal being synchronized with a second clock signal associated with the one or more second PRNGs. This feature can have the technical effect of, e.g., enabling the same seed to be available on multiple distributed controllers and/or a central orchestration device without the need for directly communicating the seed value.

In accordance with another embodiment, a computer-implemented method can include determining, by a system operatively coupled to a processor, a seed to be applied to a first PRNG associated with a first qubit of an input quantum circuit, the seed being shared with one or more second PRNGs associated with respective second qubits of the input quantum circuit that share a frame with the first qubit; and applying, by the system, selected Clifford operations to the first qubit before and after execution of respective layers of the input quantum circuit, resulting in a twirled quantum circuit, where the selected Clifford operations are selected according to an output of the first PRNG that is produced based on the seed. Benefits of the computer-implemented method can include, e.g., improved quantum circuit error mitigation through the ability to dynamically generate Pauli twirled circuits in hardware within in executing quantum program, as well as reduced messaging overhead associated with communicating parameters for Pauli twirling.

In embodiments, the determining of the seed can include receiving the seed in a control message from a control system prior to execution of the input quantum circuit, and the computer-implemented method can further include executing, by the system, the input quantum circuit at an action time specified by the control message. These features can have the technical effect of, e.g., enabling the communication of a single seed value prior to execution of the circuit instead of a complete set of parameters for Pauli twirling, which can reduce the amount of information communicated during execution. Use of a control message in this manner can also have the benefit of ensuring precise timing control for operations associated with the input quantum circuit, resulting in improved inter-qubit synchronization.

In embodiments, the selected Clifford operations can be selected from a group including an identity gate, a Pauli-X gate, a Pauli-Y gate, and a Pauli-Z gate. This can have the technical effect of enabling the space of Clifford operations to be encoded using two-bit values, which can reduce the amount of information generated and/or utilized in connection with selecting an operation.

In embodiments, the computer-implemented method can further include sampling, by the system, values from the first PRNG; and selecting, by the system, the selected Clifford operations based on a defined mapping between the values and the selected Clifford operations. Similar to the above feature, this can have the technical effect of enabling a Clifford operation to be selected in a simplified manner using random data samples and a mapping function.

In embodiments, the computer-implemented method can further include modifying, by the system and at the respective layers of the input quantum circuit, a phase of the frame of the first qubit according to a function of the selected Clifford operations. Benefits of the phase update component can include, e.g., improved hardware efficiency associated with Pauli twirling by enabling the use of pre-computed phase updates instead of parameters that are computed individually for each operation.

In embodiments, the selected Clifford operations can be first selected Clifford operations, the applying can include applying the first selected Clifford operations to the first qubit before and after execution of respective layers of a first instance of the input quantum circuit, resulting in a first twirled quantum circuit, the output of the first PRNG can be a first output, and the computer-implemented method can further include applying, by the system, second selected Clifford operations to the first qubit before and after execution of respective layers of a second instance of the input quantum circuit, resulting in a second twirled quantum circuit, the second selected Clifford operations being selected according to a second output of the first PRNG that is produced based on the seed and without reloading the input quantum circuit. These features can have the technical effect of, e.g., enabling Pauli twirling for multiple shots or instances of a given quantum circuit without requiring reloading or recompilation of the circuit.

In accordance with still another embodiment, a computer program product, facilitating a process to facilitate real-time Pauli twirling of quantum programs with control flow, can include a computer readable storage medium on which program instructions are stored. The program instructions can be executable by a processor to cause the processor to determine, by the processor, a seed to be applied to a first PRNG associated with a first qubit of an input quantum circuit, the seed being shared with one or more second PRNGs associated with respective second qubits of the input quantum circuit that share a frame with the first qubit; and apply, by the processor, selected Clifford operations to the first qubit before and after execution of respective layers of the input quantum circuit, where the selected Clifford operations are selected according to an output of the first PRNG that is produced based on the seed. Benefits of the computer program product can include, e.g., improved quantum circuit error mitigation through the ability to dynamically generate Pauli twirled circuits in hardware within in executing quantum program, as well as reduced messaging overhead associated with communicating parameters for Pauli twirling.

In embodiments, the program instructions can be further executable by the processor to cause the processor to receive, by the processor, the seed in a control message from a control system prior to execution of the input quantum circuit and to execute, by the processor, the input quantum circuit at an action time specified by the control message. These features can have the technical effect of, e.g., enabling a series of parameter values associated with a quantum circuit to be communicated via a single seed value prior to execution of the circuit, which can reduce the amount of information communicated during execution. Additionally, the use of a control message in this manner can have the benefit of ensuring precise timing control for operations associated with the input quantum circuit, resulting in improved inter-qubit synchronization.

In embodiments, the selected Clifford operations can be selected from a group including an identity gate, a Pauli-X gate, a Pauli-Y gate, and a Pauli-Z gate. This can have the technical effect of enabling the space of Clifford operations to be encoded using two-bit values, which can reduce the amount of information generated and/or utilized in connection with selecting an operation.

In embodiments, the program instructions can be further executable by the processor to cause the processor to sample, by the processor, values from the first PRNG; and select, by the processor, the selected Clifford operations based on a defined mapping between the values and the selected Clifford operations. This can have the technical effect of enabling a Clifford operation to be selected in a simplified manner using random data samples and a mapping function.

In embodiments, the program instructions can be further executable by the processor to cause the processor to modify, at the respective layers of the input quantum circuit, the phase of a frame of the first qubit according to a function of the selected Clifford operations. Benefits of this feature can include, e.g., improved hardware efficiency associated with Pauli twirling by enabling the use of pre-computed phase updates instead of parameters that are computed individually for each operation.

### DESCRIPTION OF THE DRAWINGS

FIGS. 1-2 are block diagrams of respective example, non-limiting systems that can provide a quantum control system architecture for real-time Pauli twirling of quantum programs in accordance with one or more embodiments described herein.

FIG. 3 is a diagram depicting example, non-limiting Pauli twirling operations that can be performed on a quantum circuit by the non-limiting systems of FIGS. 1-2 in accordance with one or more embodiments described herein.

FIG. 4 is a block diagram of an example, non-limiting quantum system that can be utilized in combination with the non-limiting systems of FIGS. 1-2 in accordance with one or more embodiments described herein.

FIG. 5 is a diagram depicting an example, non-limiting single qubit gate decomposition that can be utilized by the non-limiting systems of FIGS. 1-2 in accordance with one or more embodiments described herein.

FIG. 6 is a diagram depicting example Pauli gate decompositions that can be utilized by the non-limiting systems of FIGS. 1-2 in accordance with one or more embodiments described herein.

FIG. 7 is a diagram depicting an example Pauli twirling operation that can be performed by the non-limiting systems of FIGS. 1-2 in accordance with one or more embodiments described herein.

FIG. 8 is a simplified block diagram of an example, non-limiting quantum control system architecture in which the non-limiting systems of FIGS. 1-2 can operate in accordance with one or more embodiments described herein.

FIGS. 9-11 are diagrams of respective example, non-limiting parameter update schemes that can be implemented by the non-limiting systems of FIGS. 1-2 for respective parameter types in accordance with one or more embodiments described herein.

FIG. 12 is a diagram depicting another example Pauli twirling operation that can be performed by the non-limiting systems of FIGS. 1-2 in accordance with one or more embodiments described herein.

FIGS. 13A-13B are flow diagrams of one or more processes that can be performed by the non-limiting system of FIG. 2 in accordance with one or more embodiments described herein.

FIG. 14 is a block diagram of example, non-limiting classical computer environment in accordance with one or more embodiments described herein.

FIGS. 15A-15B are block diagrams of an example, non-limiting hybrid quantum-classical computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Respective qubits associated with a quantum computing system can utilize their own unique sets of stimuli to implement quantum gates and/or measurements, which can in turn result in a quantum system including many different types of hardware controllers. For instance, a quantum system can include one or more hardware controllers per qubit to facilitate implementation of a quantum program from respective associated qubits. Because many different components can be used for control in a quantum system, it is desirable to orchestrate these components to emit the correct stimuli at the correct time, e.g., based on defined calibrations, to implement a given quantum program.

By way of example, it is generally not sufficient to simply queue all of the stimuli for a quantum program ahead of time because actions that are taken in connection with a quantum program often depend on the results of previous measurements. Accordingly, it is desirable to decide the next set of gates and/or measurements to be performed, as well as the stimuli utilized for implementing those gates and/or measurements, based on the results of a previous gate or measurement. As used herein, the terms “control flow” and “quantum control flow” refer to the process of implementing quantum gates and/or performing qubit measurements in sequence based on results of prior gates and/or measurements. This process can also or alternatively be referred to as “feedforward” or “feedback” control.

Pauli twirling is a technique used to tailor the noise profile of a quantum program. This can be done in conjunction with a mitigation strategy that probabilistically undoes the noise at the cost of an exponential sampling overhead. For instance, Pauli twirling can be performed by injecting gates into a program that are selected at random from the Clifford set for Pauli twirling, which includes the identity (I) gate and the Pauli X, Y, and Z gates, in order to generate an exponential of random programs that are equivalent to the original program. These random programs can be structured such that a quantum computing system can, over an ensemble of measurements, undo some of the noise that may accumulate in the program due to, e.g., the constraints and/or imperfections of real-world hardware.

Because Pauli twirling involves the injection and/or transformation of gates with randomly selected gates, the computational expense associated with generating an exponential number of random programs in this manner presents technical problems that degrade the performance of a quantum computer. For instance, Pauli twirling often utilizes a large amount of recompilation, reloading, and resynchronization, which can lead to low quantum processing unit (QPU) utilization.

To exacerbate the above-described technical problems, pre-computed parameters are not sufficient for Pauli twirling in the presence of control flow, e.g., because effective Pauli twirling depends on new sets of parameters that are generated and reloaded for each program to be run. Moreover, even in an implementation where real-time parameters are used, it is very expensive in terms of time, communication bandwidth, etc., to distribute all of the parameters associated with Pauli twirling each layer of a circuit, and/or each gate in each layer. Furthermore, in order to combine control flow with Pauli twirling, pre-computed parameters cannot be used because the manner in which parameters are mapped to phase updates can depend on the previous gates that were applied, which generally cannot be determined in the presence of control flow unless decisions are computed and accumulated at runtime.

To the furtherance of the above and/or related ends, embodiments described herein can facilitate dynamic generation of Pauli twirled circuits within an executing program in a manner that can work seamlessly with control flow and an associated block engine. For instance, embodiments described herein can facilitate efficient Pauli twirling in hardware without reloading, e.g., by efficiently computing and/or applying sampled Clifford operations in hardware during program execution. Embodiments described herein can further facilitate combining a block engine with Pauli twirling to express and execute a single program execution in hardware that performs twirled samples. Additionally, embodiments described herein can provide techniques for efficient and distributed tracking of shared qubit frames without communication through shared seeded pseudorandom number generators (PRNGs). Among other benefits, this can reduce program footprints and communication bandwidth usage for mitigation programs, improve quantum error correction performance, and/or provide other similar benefits.

As used herein, the term “Clifford gate” refers to a quantum gate described by unitary matrix U with the property that if P is an n-qubit Pauli, then either UPU^{†} or −UPU^{†} is also an n-qubit Pauli. Clifford gates include all Pauli gates as well as other gates, such as, but not limited to CNOT and CZ gates. Similarly, the term “Clifford operation” refers to an operation performed via a Clifford gate.

As used herein, the term “non-Clifford gate” refers to a quantum gate that is not a Clifford gate. Non-Clifford gates include, but are not limited to quantum gates such as R_{Z}(θ)=e^{-iθ/2 Z} (for arbitrary angles θ) or partially-entangling R_{ZZ}(θ)=e^{-iθ/2 Z⊗Z} gates for arbitrary angles θ.

As used herein, the term “data” can comprise metadata.

As used herein, the terms “entity,” “requesting entity,” and “user entity” can refer to a machine, device, component, hardware, software, smart device, party, organization, individual and/or human.

As used herein, the term “block engine” refers to a control scheme for a distributed quantum computing system in which a central controller device performs branching decisions for the system and directs individual qubit controller devices to execute blocks of instructions based on those branching decisions.

### DESCRIPTION

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

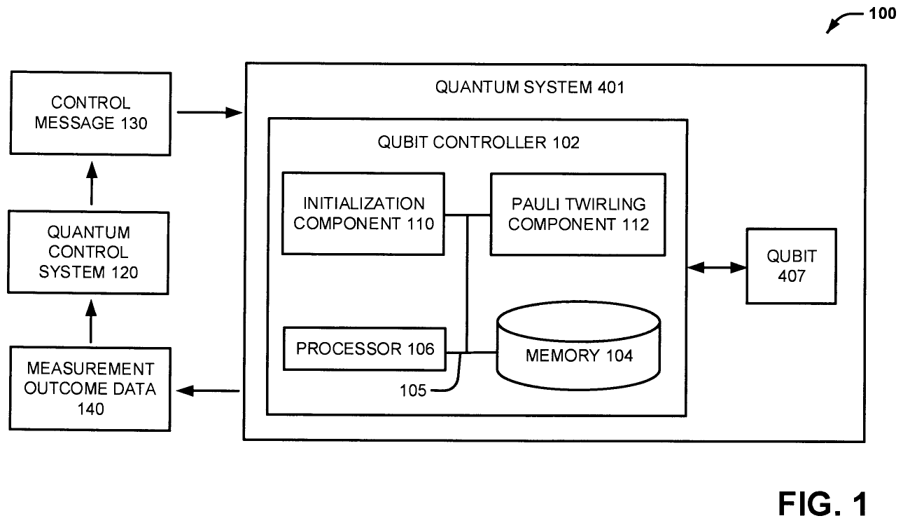

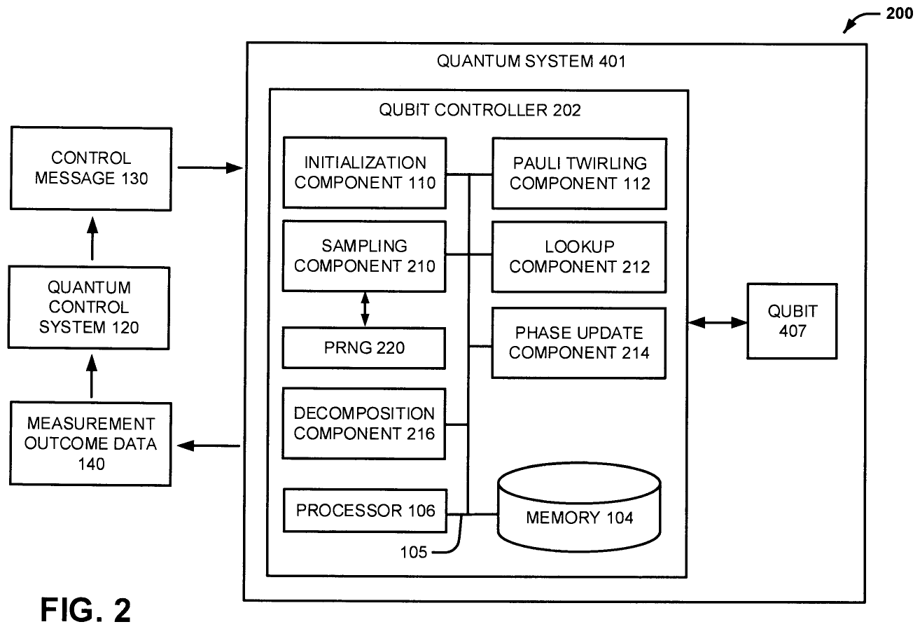

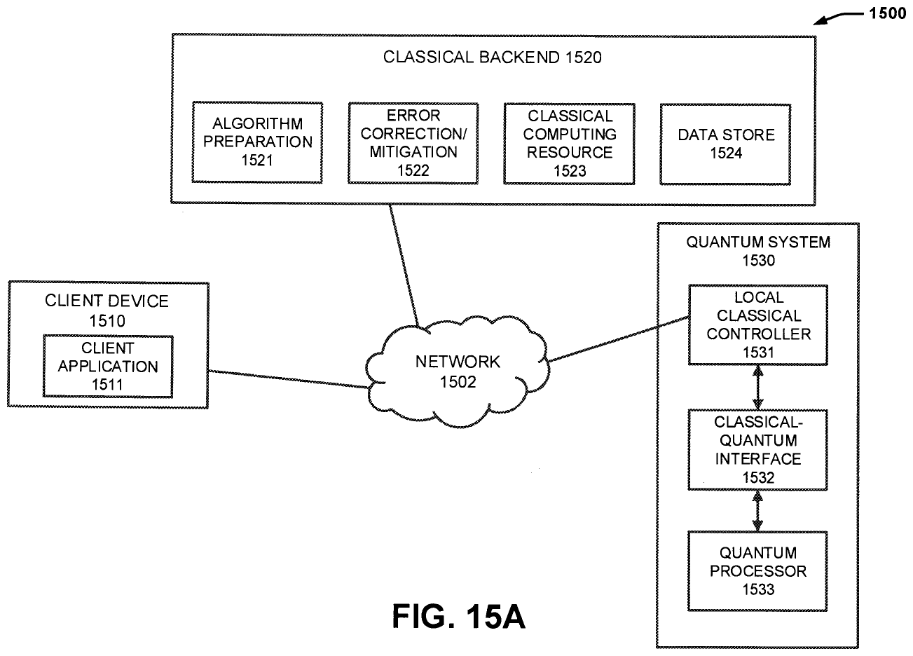

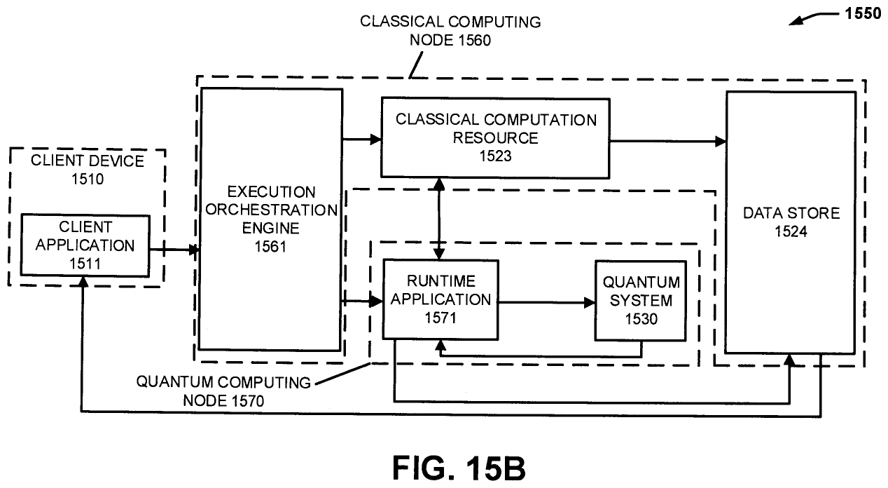

For example, in one or more embodiments, the non-limiting systems 100 and/or 200 illustrated at FIGS. 1-2, and/or systems thereof, can further comprise one or more computer and/or computing-based elements described herein with reference to a computing environment, such as the classical computing environment 1400 illustrated at FIG. 14 or the hybrid quantum-classical computing environment 1500 illustrated at FIGS. 15A-15B. In one or more described embodiments, computer and/or computing-based elements can be used in connection with implementing one or more of the systems, devices, components and/or computer-implemented operations shown and/or described in connection with FIGS. 1-2, and/or with other figures described herein.

Turning now in particular to the figures, and first to FIG. 1, illustrated is a block diagram of an example, non-limiting system 100 that can facilitate a quantum control system architecture for real-time Pauli twirling of quantum programs. The non-limiting system 100 can comprise a quantum control system 120 and a quantum system 401 that includes one or more qubit controllers 102, which can interface with respectively associated qubits 407. While only one qubit controller 102 and qubit 407 are shown in FIG. 1, it is noted that the quantum system 401 can include any suitable number of qubit controllers 102 and/or qubits 407. Further, while FIG. 1 illustrates a one-to-one mapping between a qubit controller 102 and a qubit 407, it is noted that there could instead be a many-to-one, one-to-many, and/or many-to-many mapping between qubit controllers 102 and qubits 407 as appropriate.

It is additionally noted that the qubit controller 102 is only briefly detailed to provide but a lead-in to a more complex and/or more expansive qubit controller 202 as illustrated at FIG. 2. That is, further detail regarding processes that can be performed by one or more embodiments described herein will be provided below relative to the non-limiting system 200 of FIG. 2.

Still referring to FIG. 1, the qubit controller 102 can comprise at least a memory 104, bus 105, processor 106, initialization component 110, and Pauli twirling component 112. Using these components, the qubit controller 102 can perform operations based on real-time control sequences indicated in a control message 130 provided by a quantum control system 120, such as sending waveform stimuli or other stimuli to an associated qubit 407 and performing corresponding measurements. The qubit controller 102 can then, e.g., via the quantum system 401, provide measurement outcome data 140 associated with those measurements back to the quantum control system 120, e.g., to enable further decision making at the quantum control system 120.

With respect to the components of the qubit controller 102 shown in FIG. 1, the initialization component 110 can determine a seed to be applied to a PRNG that is associated with a qubit 407 of an input quantum circuit. As will be described in further detail below, e.g., with respect to FIG. 2, the seed can be shared with other PRNGs that are associated with other qubits 407 of the input quantum circuit that are not shown in FIG. 1. By way of example, the seed can be shared with one or more PRNGs associated with respective qubits, which can include zero qubits or any number of one or more qubits, that share a frame with the qubit 407 associated with the qubit controller 102 shown in FIG. 1. In some embodiments, the initialization component 110 can determine the seed to be applied based on information received from the quantum control system 120, e.g., in a control message 130 from the quantum control system in which the seed is embedded. In other embodiments, the initialization component 110 can derive the seed from information locally available to the qubit controller 102, such as a clock signal local to the qubit controller 102 that is synchronized with clock signals associated with other qubit controllers 102 in the non-limiting system 100, the quantum control system 120, and/or other devices or systems.

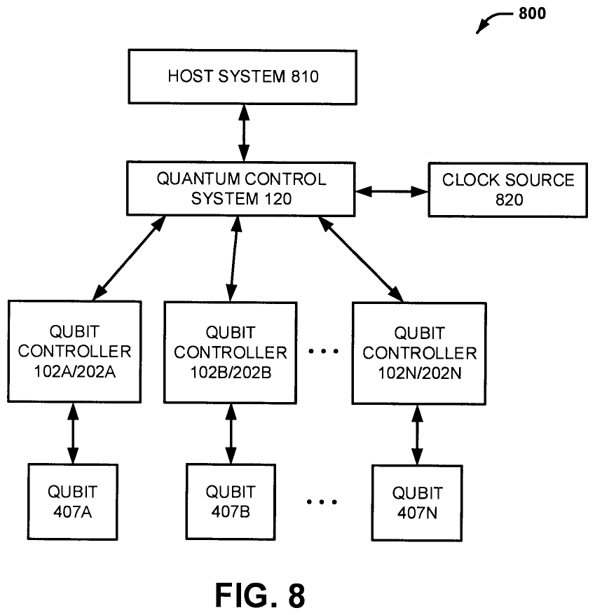

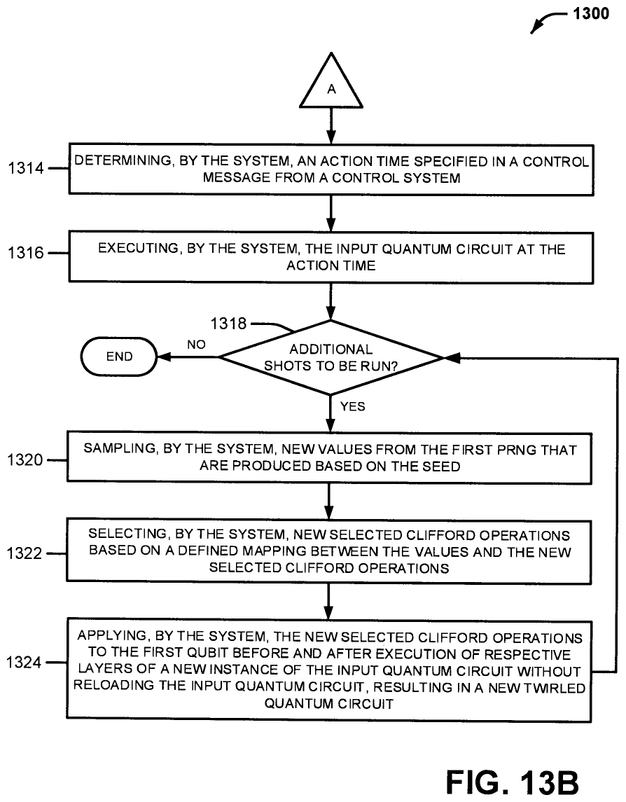

Subsequent to initializing the PRNG according to the determined seed, the Pauli twirling component 112 can apply selected Clifford operations to the qubit 407 before and after execution of respective layers of the input quantum circuit, resulting in a twirled quantum circuit. For example, the Pauli twirling component 112 could apply a first selected Clifford operation before execution of a given layer and then apply a second Clifford operation, which is the inverse of the first selected Clifford operation, after execution of the layer. Examples of Clifford operations that can be performed by the Pauli twirling component 112 are described in further detail below with respect to FIGS. 7 and 12.

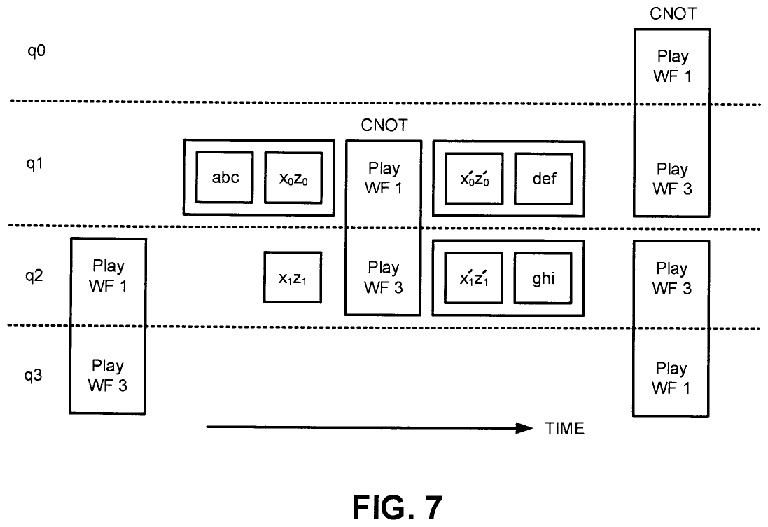

In embodiments, the selected Clifford operations applied by the Pauli twirling component 112 can be selected according to an output of the PRNG that is produced based on the seed determined by the initialization component 110 with which the PRNG is initialized. By way of example, a value of a fixed or variable bit length can be sampled from the PRNG, based on which an appropriate Clifford gate can be applied for a given layer of the circuit. Examples of gates that can be applied in this manner, and techniques that can be used to map a PRNG sample to a given type of gate, are described in further detail below with respect to FIG. 6.

Turning next to FIG. 2, a non-limiting system 200 is illustrated that can comprise a quantum system 401 comprising a qubit controller 202. Repetitive description of like elements and/or processes employed in respective embodiments is omitted for brevity. Description relative to an embodiment of FIG. 1 can be applicable to an embodiment of FIG. 2. Likewise, description relative to an embodiment of FIG. 2 can be applicable to an embodiment of FIG. 1.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The qubit controller 202 can comprise a plurality of components. The components can comprise a memory 104, processor 106, bus 105, initialization component 110, Pauli twirling component 112, sampling component 210, lookup component 212, phase update component 214, decomposition component 216, and PRNG 220. Using these components, the qubit controller 202 can dynamically generate Pauli twirled circuits within an executing program, e.g., in a manner that seamlessly works with control flow and an associated block engine.

Discussion next turns briefly to the processor 106, memory 104 and bus 105 of the qubit controller 202. For example, in one or more embodiments, the qubit controller 202 can comprise the processor 106 (e.g., computer processing unit, microprocessor, classical processor, quantum processor and/or like processor). In one or more embodiments, a component associated with qubit controller 202, as described herein with or without reference to the one or more figures of the one or more embodiments, can comprise one or more computer and/or machine readable, writable and/or executable components and/or instructions that can be executed by processor 106 to provide performance of one or more processes defined by such component and/or instruction. In one or more embodiments, the processor 106 can comprise the initialization component 110, Pauli twirling component 112, sampling component 210, lookup component 212, phase update component 214, and decomposition component 216. In various embodiments, the processor 106 can also comprise the PRNG 220, or the PRNG 220 can be implemented at least in part via dedicated hardware.

In one or more embodiments, the qubit controller 202 can comprise the computer-readable memory 104 that can be operably connected to the processor 106. The memory 104 can store computer-executable instructions that, upon execution by the processor 106, can cause the processor 106 and/or one or more other components of the qubit controller 202 (e.g., initialization component 110, Pauli twirling component 112, sampling component 210, lookup component 212, phase update component 214, and decomposition component 216) to perform one or more actions. In one or more embodiments, the memory 104 can store computer-executable components (e.g., initialization component 110, Pauli twirling component 112, sampling component 210, lookup component 212, phase update component 214, and decomposition component 216).

The qubit controller 202 and/or a component thereof as described herein, can be communicatively, electrically, operatively, optically and/or otherwise coupled to one another via a bus 105. Bus 105 can comprise one or more of a memory bus, memory controller, peripheral bus, external bus, local bus, quantum bus and/or another type of bus that can employ one or more bus architectures. One or more of these examples of bus 105 can be employed.

In one or more embodiments, the qubit controller 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the qubit controller 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the quantum control system 120 and the quantum system 401 (including the qubit controller 202).

In addition to the processor 106 and/or memory 104 described above, the qubit controller 202 can comprise one or more computer and/or machine readable, writable and/or executable components and/or instructions that, when executed by processor 106, can provide performance of one or more operations defined by such component and/or instruction.

Discussion next turns to the additional components of the qubit controller 202 (e.g., initialization component 110, Pauli twirling component 112, sampling component 210, lookup component 212, phase update component 214, and decomposition component 216). As described above with respect to FIG. 1, the Pauli twirling component 112 can apply selected Clifford operations to a qubit 407 before and after execution of respective layers of an input quantum circuit that includes the qubit 407.

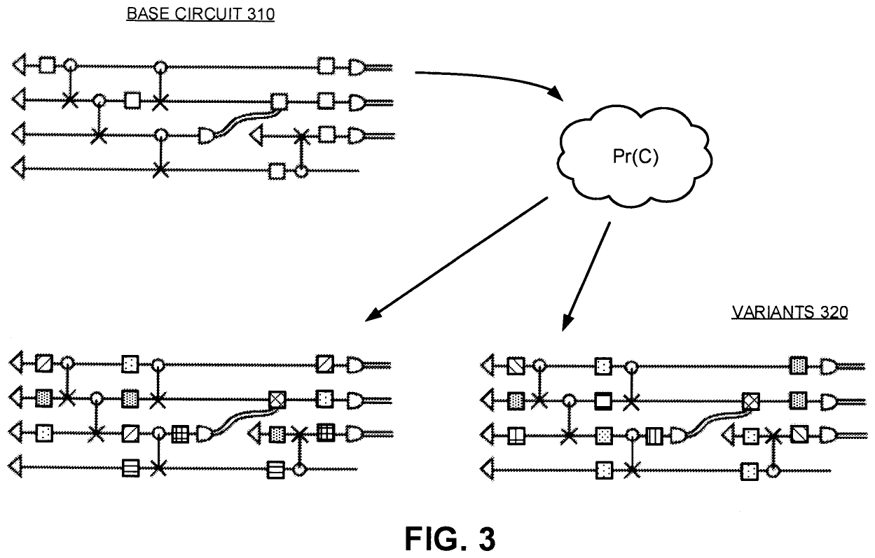

Referring to FIG. 3, and with additional reference to FIG. 2, example, non-limiting Pauli twirling operations that can be performed by the Pauli twirling component 112 for a generic base circuit 310 are illustrated. In general, twirling, and Pauli twirling more specifically, is a method to tailor the noise profile of a base circuit 310 by strategically sampling structurally similar random circuits. For instance, twirling as shown by FIG. 3 can include modifying a base circuit 310 according to a probability function and/or other means to generate variants 320 of the base circuit, e.g., through the addition and/or alteration of gates such that each variant 320 is equivalent to the base circuit 310 while being physically distinct in structure from the base circuit 310. More particularly, in between each of the qubit layers of the base circuit 310, which can be visualized as columns of the base circuit 310, the Pauli twirling component 112 can select a set of random Pauli gates to be merged into the circuit. For example, the Pauli twirling component 112 can take a base circuit 310, split it into layers, and then at leach layer for each qubit apply a random Clifford operation before and after the qubit.

While exceptions exist, most variants 320 of a base circuit 310 that are sampled via twirling exhibit a number of common properties. For instance, most variants 320 can be structurally identical in their schedule to their corresponding base circuit 310. Additionally, most variants 320 can be logically equivalent to their corresponding base circuit 310. Further, twirling can generally increase the gate count of a variant 320 compared to a base circuit 310, and the aggregate noise model of most variants 320 can have less coherent error than that of the base circuit 310. Moreover, in the absence of any circuit switching overhead, sampling one shot from each variant 320 can typically be optimal.

Returning to FIG. 2, the sampling component 210 can facilitate the selection of Clifford operations to be applied during Pauli twirling by sampling values from the PRNG 220, which can be initialized according to a seed determined by the initialization component. For example, the initialization component 110 can receive the seed for the PRNG 220 in a control message 130 from the quantum control system 120 prior to execution of a given quantum circuit. The control message 130 can additionally cause the qubit controller 202 to execute the quantum circuit, including sampling via the sampling component 210 and/or other operations performed by the other components of the qubit controller 202, at an action time that is specified by the control message. This can, among other benefits, ensure synchronized operation of respective qubit controllers 202 within the quantum system 401 as well as reduce or eliminate time gaps between waveform emission and/or other qubit operations. The initialization component 110 could also or alternatively determine the seed using other suitable approaches, such as by deriving the seed based on a common clock signal that is synchronized between respective devices of the non-limiting system 200. Based on the values sampled by the sampling component 210, the lookup component 212 can select the Clifford operations to be applied based on a defined mapping between the sampled values and the selected Clifford operations. An example mapping that can be used in this manner is described below with respect to FIG. 6.

By selecting Clifford operations for Pauli twirling using the sampling component 210 and lookup component 212 as described above, the qubit controller 202 can implement Pauli twirling in hardware in a single program execution for many unique samples such that, in the single shot limit for quantum programs, the qubit controller 202 can perform a unique twirled sample. For example, the qubit controller 202 can, according to embodiments as described herein, facilitate Pauli twirling via numerically controlled oscillators (NCOs) and special purpose instructions without providing for communication regarding the actions taken for each qubit 407 in the quantum system 401.

The above can be beneficial for operations such as virtual Z gates, where coupled qubits 407 desirably track the frame of neighboring qubits 407 and multiple qubit controllers 202 can leverage knowledge of the frame of those qubits 407. In such a scenario, communication of each selected parameter value for Pauli twirling between neighboring qubits 407 would utilize a prohibitive amount of communication, both in terms of communication bandwidth and the time associated with such communication. Instead, the non-limiting system 200 shown in FIG. 2 can facilitate the use of commonly initialized PRNGs 220 at respective qubit controllers 202 that share a common seed, e.g., as provided via the quantum control system 120. By doing so, the PRNGs 220 can behave deterministically provided that each of the PRNGs 220 are started at the same time and sampled in the same order, which can be ensured for cases in which a unique PRNG exists for each frame.

By utilizing a PRNG-based approach via the sampling component 210 and lookup component 212, Pauli twirling within system 200 can be simplified such that for each shot to be run by system 200, the quantum control system 120 can simply reset the seed of the PRNG 220 at the qubit controller 202. As a result, instead of sending a unique value for each gate that is applied for each Pauli twirl event, one parameter can be sent at the start of each shot or circuit that is run by the qubit controller 202. This can, in turn, significantly reduce the amount of information communicated within system 200.

Additionally, use of a PRNG-based approach as described above can enable multiple shots of Pauli twirling to be performed by the qubit controller 202 for a given quantum circuit without reloading or recompiling a program associated with the circuit. For instance, the Pauli twirling component 112 can apply first selected Clifford operations at respective layers of a first instance of an input quantum circuit based on first PRNG values sampled by the sampling component 210, resulting in a first twirled circuit, and then apply second selected Clifford operations at respective layers of a second instance of the same circuit based on second PRNG values sampled by the sampling component 210.

Once the value of each gate that is to be twirled by the Pauli twirling component 112 is chosen for each layer of a given circuit, the qubit controller 202 can additionally compute the impact of the selected gates on the future gates to be twirled. To this end, the phase update component 214 of the qubit controller 202 can account for this impact by modifying, at the respective layers of an input quantum circuit where Clifford operations have been applied for Pauli twirling, a phase of a frame of the associated qubit 407 according to a function of the selected Clifford operations. In embodiments, the phase update component 214 can accomplish this via the use of special purpose instructions, e.g., as will be described in further detail below with respect to FIG. 6. Phase updates as applied by the phase update component 214 can also be based on single-qubit gate decompositions that are produced by the decomposition component 216 of the qubit controller 202, which will also be described in further detail below with respect to FIG. 6.

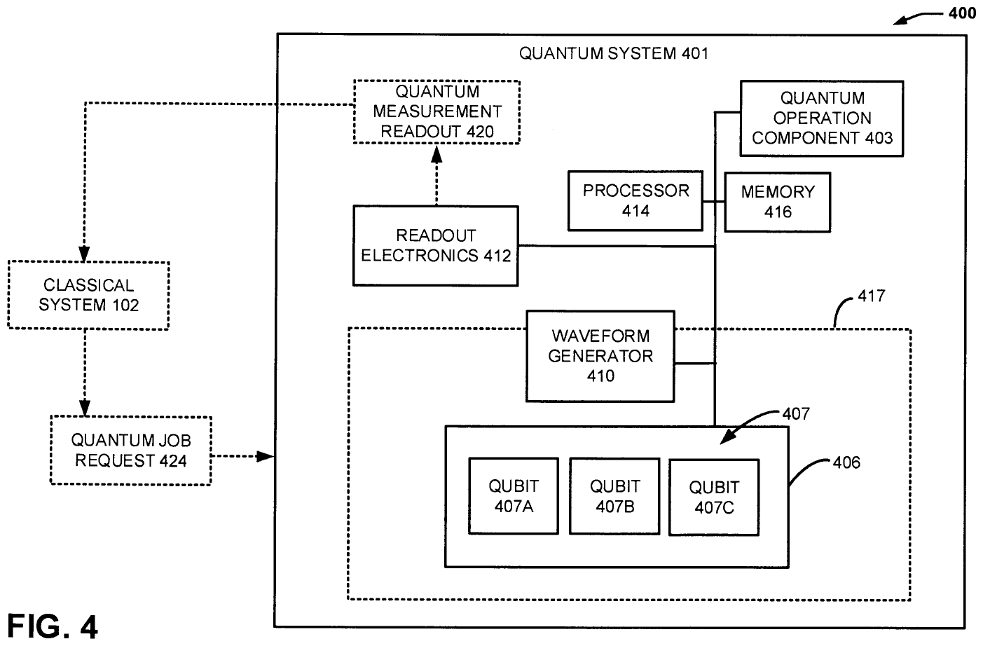

Turning now to FIG. 4, one or more embodiments described herein can include one or more devices, systems and/or apparatuses that can facilitate a quantum control system architecture for real-time Pauli twirling of quantum programs. Accordingly, at FIG. 4, illustrated is a block diagram of an example, non-limiting system 400 that can at least partially facilitate such an architecture.

As illustrated at FIG. 4, the non-limiting system 400 can comprise a quantum system 401 that can be employed with or separate from the classical system 120 as described above. Generally, the quantum system 401 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 420, can be responsive to the quantum job request 424 and associated input data and can be based at least in part on the input data, quantum functions and/or quantum computations.

In one or more embodiments, the quantum system 401 can comprise components, such as a quantum operation component 403, a quantum processor 406, pulse component 410 (e.g., a waveform generator) and/or readout electronics 412 (e.g., a readout component). In one or more other embodiments, the readout electronics 412 can be comprised at least partially by the classical system 120 and/or be external to the quantum system 401. The quantum processor 406 can comprise one or more, such as plural, qubits 407. Individual qubits 407A, 407B and 407C, for example, can be fixed frequency and/or single junction qubits, such as transmon qubits.

In one or more embodiments, a memory 416 and/or processor 414 can be associated with the quantum operation component 403, where suitable. The processor 414 can be any suitable processor. The processor 414 can generate one or more instructions for controlling the one or more processes of the quantum operation component 403. In embodiments, the processor 414 and memory 416 can also be associated with sub-elements of the quantum system 401, such as the qubit controllers 102/202 described above with respect to FIGS. 1-2.

The quantum operation component 403 can obtain (e.g., download, receive, search for and/or the like) a quantum job request 424 requesting execution of one or more quantum programs and/or a physical qubit layout. The quantum job request 424 can be provided in any suitable format, such as a text format, binary format and/or another suitable format. In one or more embodiments, the quantum job request 424 can be obtained by a component other than of the quantum system 401, such as a by a component of the classical system 120.

The quantum operation component 403 can determine mapping of one or more quantum logic circuits for executing a quantum program. In one or more embodiments, the quantum operation component 403 and/or quantum processor 406 can direct the waveform generator 410 to generate one or more pulses, tones, waveforms and/or the like to affect one or more qubits 407, such as in response to a quantum job request 424.

The waveform generator 410 can generally cause the quantum processor 406 to perform one or more quantum processes, calculations and/or measurements by creating a suitable electro-magnetic signal. For example, the waveform generator 410 can operate one or more qubit effectors, such as qubit oscillators, harmonic oscillators, pulse generators and/or the like to cause one or more pulses to stimulate and/or manipulate the state(s) of the one or more qubits 407 comprised by the quantum system 401.

The quantum processor 406 and a portion or all of the waveform generator 410 can be contained in a cryogenic environment, such as generated by a cryogenic environment 417, such as effected by a dilution refrigerator. Indeed, a signal can be generated by the waveform generator 410 to affect one or more of the plurality of qubits 407. Where the plurality of qubits 407 are superconducting qubits, cryogenic temperatures, such as about 4K or lower, can be employed for function of these physical qubits. Accordingly, one or more elements of the readout electronics 412 also can be constructed to perform at such cryogenic temperatures.

The readout electronics 412, or at least a portion thereof, can be contained in the cryogenic environment 417, such as for reading a state, frequency and/or other characteristic of the qubits 407, e.g., excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

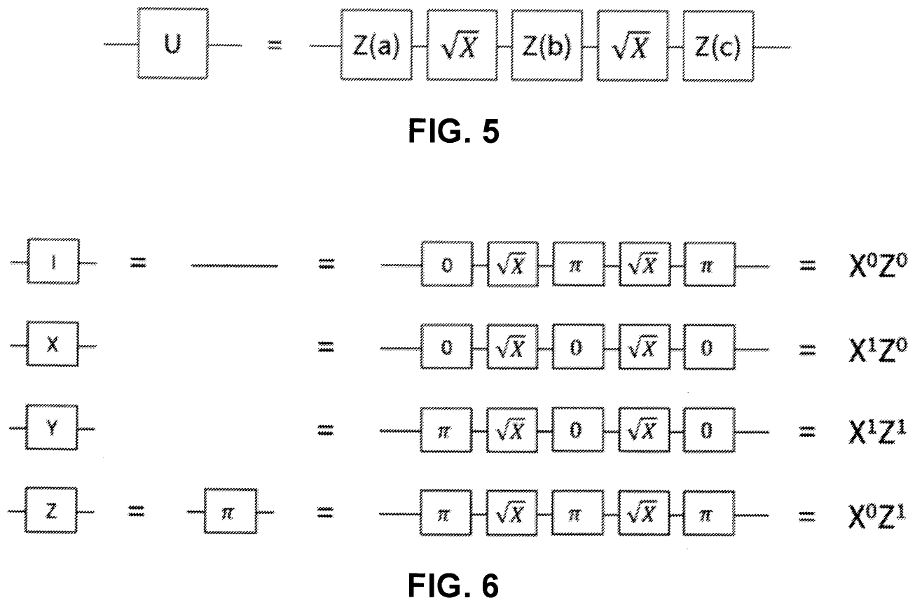

Referring next to FIG. 5, and with additional reference to FIG. 2, an example, non-limiting single qubit gate decomposition that can be utilized by the non-limiting systems of FIGS. 1-2 is illustrated. In general, the decomposition component 216 of the qubit controller 202 shown in FIG. 2 can define a rotation of an associated qubit 407 via a series of quantum gates, such that the phase update component 214 of the qubit controller can modify the phase of the frame of the qubit 407 by applying a phase rotation to at least one gate of the series of gates.

An example of a series of gates that can be utilized by the decomposition component 216 is shown by FIG. 5, where an arbitrary single-qubit gate can be decomposed into three parameterized RZ gates, associated with parameters A, B, and C, respectively, and two VX gates. Based on this framework, a quantum gate can be expressed as U (A, B, C), where A, B, and C are the parameters applied to the respective RZ gates. It is noted, however, that FIG. 5 illustrates merely one non-limiting example of a series of gates that can be utilized by the decomposition component 216 and that other decompositions could also be used.

Based on the structure shown in FIG. 5, the decomposition component 216 of the qubit controller 202 shown in FIG. 2 can, in one embodiment, define a rotation of a given qubit 407 via a series of quantum gates including the first RZ gate (Z (a)), the first VX gate, the second RZ gate (Z (b)), the second VX gate, and the third RZ gate (Z (c)) shown in FIG. 5. The phase update component 214 can then modify a phase of a frame of the qubit 407 by applying a phase rotation to at least one of the RZ gates. In an embodiment, the phase update component 214 can receive instructions that encode the parameterization shown in FIG. 5 as respective phase updates on an NCO that track the qubit frame, where an amount of phase rotation to apply for each of the RZ gates is defined via the instructions. Based on these instructions, the phase update component 214 can perform the operations shown in FIG. 5 by applying a first NCO update corresponding to parameter A, playing the waveform that corresponds to the square root of X, applying a second NCO update corresponding to parameter B, repeating the waveform that corresponds to the square root of X, and then applying a third NCO update corresponding to parameter C. As a result, with a single waveform and a series of frame updates that can be efficiently executed in hardware, an arbitrary qubit rotation can be encoded with minimal error.

Turning now to FIG. 6, example, non-limiting Pauli gate decompositions that can be utilized by the qubit controller 202 shown in FIG. 2 are provided. More particularly, FIG. 6 shows the Paulis for Pauli twirling, namely the identity (I) gate, Pauli-X gate, Pauli-Y gate, and Pauli-Z gate, and their decompositions into RZ and VX gates in the manner described above with respect to FIG. 5. As FIG. 6 illustrates, if the set of gates to be communicated to a qubit controller 202 is restricted to the Paulis, each type of Pauli can be encoded in two bits of information, which yield four options. Accordingly, as shown in FIG. 6, an X bit and a Z bit can be used to map the gate space for Pauli twirling, e.g., by using X⁰Z⁰, X¹Z¹, X¹Z¹, and X⁰Z¹ for an I, X, Y, and Z gate, respectively. Stated another way, an arbitrary Pauli can be encoded as shown in FIG. 6 using an X gate and a Z gate, e.g., with bits representing whether or not the X gate and/or Z gate are applied for a given Pauli.

As further shown by FIG. 6, each of the four values associated with the respective Paulis can be achieved with fixed NCO updates corresponding to the respective gate types. Thus, for each Pauli to be inserted into a given layer of a circuit, the sampling component 210 of the qubit controller 202 can select the Pauli, which can be encoded by two bits of information, and then the phase update component 214 can map that data onto the qubit frame using the NCO updates depicted by FIG. 6.

By way of example, for an X gate as shown by FIG. 6, the phase update component 214 can hold the VX gates fixed and apply no frame update in each of the frame update events. As another example, the phase update component 214 can implement a Y gate by holding the VX gates fixed, applying a rotation of π at the first frame update event, and then applying no frame update in each of the remaining frame update events.

By utilizing fixed NCO updates as shown in FIG. 6, frame updates can be computed, e.g., by the phase update component 214, automatically based on the Pauli that was sampled at runtime. If, instead, the NCO updates had to be computed at runtime, such computation would consume a large number of instructions and potentially involve the use of costly floating point math functions. In contrast, a qubit controller 202 can combine sampling of a Pauli from the PRNG 220 along with efficient frame updates based on the Pauli that was sampled and special-purpose instructions to perform Pauli twirling directly in the hardware in an efficient manner.

Referring next to FIG. 7, an example, non-limiting Pauli twirling operation that can be performed by a qubit controller 202 as shown in FIG. 2 is illustrated. The non-limiting example shown by FIG. 7 represents a portion of a quantum program, in which arbitrary gates are performed prior to a CNOT that is desirably twirled. The “Play WF (waveform)” operations shown in FIG. 7 correspond to emission of respective waveform stimuli, e.g., as given by the number accompanying the instruction. An arbitrary Pauli, here represented by X0Z0 or X1Z1, can then be twirled into the appropriate layer. The addition of the arbitrary Pauli can have an impact on the frame of the inverse Pauli that can be untwirled after the layer. As a result, the frame updates (abc) can be mixed with the random Pauli updates, and then appropriate frame updates (def and/or ghi) can be utilized to negate this impact.

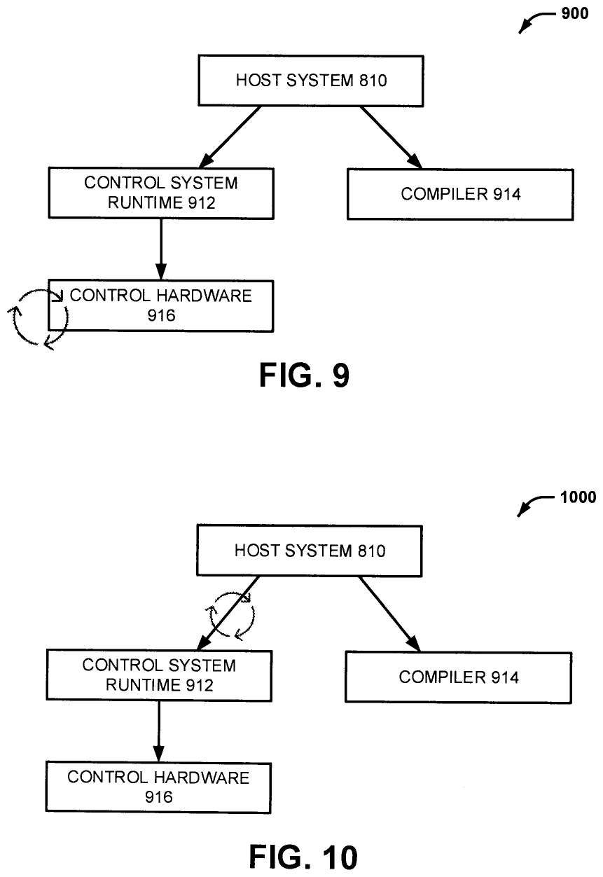

With reference now to FIG. 8, and with further reference to FIGS. 1-2, a non-limiting example system 800 facilitating communication between a host system 810, a quantum control system 120, and qubit controllers, here N qubit controllers 102A/202A-102N/202N, is illustrated. It is noted that the numbering convention used for the qubit controllers 102/202 and their associated qubits 407A-407N is not intended to imply any specific number of qubit controllers and/or qubits.

The host system 810 can include one or more computing devices, e.g., general-purpose computing devices, which can provide respective classical computing functionality for the non-limiting system 800. This functionality can include, but is not limited to, providing an interface between the non-limiting system 800 and client computing devices (e.g., to enable client applications or programs to be executed on the non-limiting system), facilitating general operation and/or management of the non-limiting system 800, and/or other functionality.

As further shown in FIG. 8, the quantum control system 120 can be responsible for making decisions in connection with a given quantum application or program. The quantum control system 120 can maintain communication links to the respective qubit controllers 102/202, e.g., via a low-latency messaging network, e.g., comprising midplane connections between the quantum control system 120 and qubit controllers 102/202. In embodiments, the messaging network between the quantum control system 120 and the qubit controllers 102/202 can enable the quantum control system 120 to send, with low latency, decisions to the qubit controllers 102/202 regarding blocks to execute, specific times at which to execute those blocks, and parameters to use used during block execution (e.g., for live value parameters).

The qubit controllers 102/202 can, in turn, be connected, e.g., via wired connections, to respectively associated qubits 407, which can be located in a cryogenic environment and/or other environment suitable for proper operation of the qubits 407. While not shown in FIG. 8, the qubit controllers 102/202 could also include additional network interfaces, such as an Ethernet interface or the like, to enable direct communication between the qubit controllers 102/202 and the host system 810 and/or other components of the non-limiting system 800. Direct communication between the qubit controllers 102/202 and the host system 810 can be used, e.g., for the transfer of parameter values to the qubit controllers 102/202 for a given quantum job.

As further shown in FIG. 8, the quantum control system 120 can be communicatively coupled to a clock source 820, which can include one or more software and/or hardware elements that facilitate providing a shared or common clock signal to respective devices in the non-limiting system 800. For instance, as shown, the quantum control system 120 can access the common clock signal directly via its direct coupling to the quantum control system 120, and the respective qubit controllers 102/202 can access the common clock signal using, e.g., the messaging network described above that couples the quantum control system 120 to the qubit controllers 102/202. By enabling the use of a common clock signal via the clock source 820, each of the devices in the non-limiting system 800 can reference the same notion of time, which can facilitate improved synchronization of the devices in the non-limiting system 800.

Other implementations of the clock source 820 are also possible. For instance, the clock source 820 could be implemented as part of the host system 810, and respective devices of the non-limiting system 800 can access an associated shared clock signal via the host system 810. In other implementations, the clock source 820 could communicate directly with multiple different types of devices in the non-limiting system 800, such as the quantum control system 120 and the qubit controllers 102/202. In still other implementations, the clock source 820 could be integrated into the quantum control system 120 and/or one or more of the qubit controllers 102/202. Other implementations are also possible.

The non-limiting system 800 shown in FIG. 8 can be utilized to alter the execution model of a quantum program in a manner that provides enhanced synchronization between the elements of the non-limiting system 800. For instance, instead of the quantum control system 120 communicating a decision value to the qubit controllers 102/202 and then causing the qubit controllers 102/202 to do their own individual branching decisions, the quantum control system 120 can explicitly communicate (e.g., via a control message 130 as shown in FIGS. 1-2) the next block to execute, and specific times at which to execute the instructions in that block, to the qubit controllers 102/202. This can have the effect of moving branching decisions from the individual qubit controllers 102/202 to the quantum control system 120, thereby removing a potential source of desynchronization between the qubit controllers 102/202.

While FIG. 8 illustrates a system 800 that includes one quantum control system 120, it is noted that implementations of system 800 could also include multiple quantum control systems 120, which could be arranged, for example, hierarchically and/or as peer systems. Also or alternatively, multiple quantum control systems 120 within system 800 could be arranged according to any suitable network topology or topologies, such as a tree-like, star-like, or hypercube-like topology, and/or other topologies. In an implementation that utilizes multiple quantum control systems 120, the quantum control systems 120 could be communicatively coupled to each other, and/or to the host system 810 and/or qubit controllers 102/202, via any suitable communication technologies.

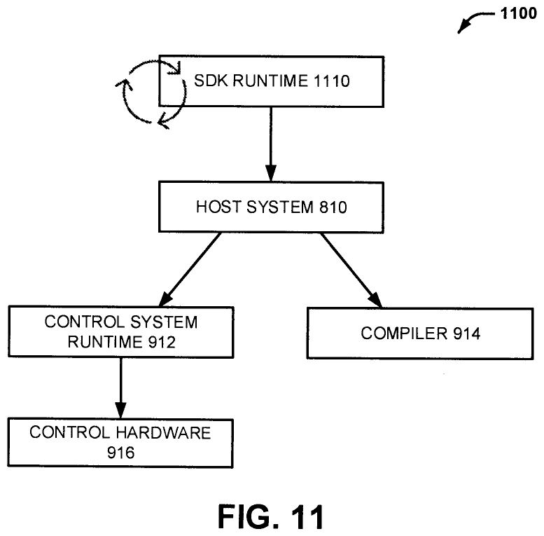

With further reference to FIGS. 1-2, discussion turns next to FIGS. 9-11, which depict respective example, non-limiting parameter update schemes that can be implemented for respective parameter types in accordance with one or more embodiments described herein. For purposes of explanation, parameters that can be provided by the quantum control system 120 to a qubit controller 102/202 can be classified into different classes, or types, of parameters. These types can include, but are not necessarily limited to, the following:
1) Parametric values injected by the host during job initialization. These parameters can result in changes to the program stored in memory, modifying specific values that could then be combined with constants or live values to modify waveform generation or NCO updates. Parameters of this type can be invoked between executions, and the values of these parameters can be communicated to an affected qubit controller 102/202 prior to runtime.
2) Parametric values that are computed by the quantum control system 120 based on measurements or centralized computation during execution of a job. This computations can result in live values, which can then be communicated to the corresponding qubit controllers 102/202 to impact waveform generation, NCO updates, PRNG initialization, and/or other operations as described above. By way of example, parameters of this type can be generated based on the results of performing a measurement on a qubit, and code can subsequently be executed based on the parameter values, e.g., by dynamically patching the relevant qubit rotations based on the determined values. It is noted that while parameters of this type can be modified during execution of a job, these modifications can be performed without modifying the waveform timing of the underlying program. This can, for instance, enable the use of parameters of this type with synchronized control flow between qubits.

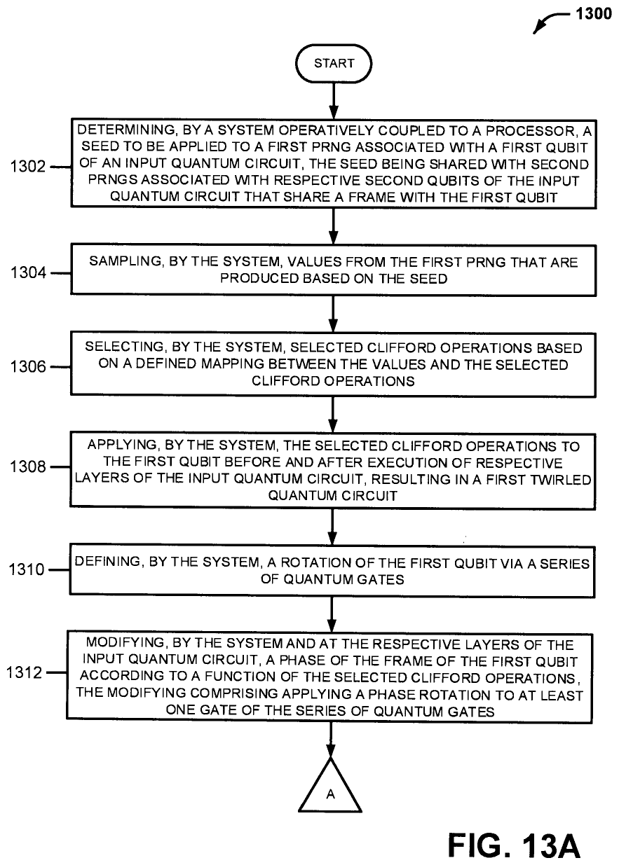

Referring back to FIGS. 9-11, respective example parameter updates are depicted for a non-limiting example quantum computing framework including a host system 810 that interacts with a control system runtime 912 and a compiler 914. The control system runtime 912, in turn, can facilitate operation of associated control hardware 916, which can include both the components of a quantum control system 120 as described above as well as elements of a quantum system 401, such as qubit controllers 102 or the like. In FIG. 11, the framework can additionally include a software development kit (SDK) runtime 1110, which can drive operation of the host system 810.

Focusing now on FIG. 9, an example of real-time parameter updates is provided, e.g., in which the parameter updates reside on the control hardware 916 and execute in real time. As these updates are resident on the control hardware 916, these updates can generally be faster than other types of parameter updates that can be performed via the quantum control system 120. For instance, parameter updates as shown by FIG. 9 can occur with a latency on the order of nanoseconds to microseconds. Real-time parameter updates as shown by FIG. 9 can be used for dynamic quantum jobs, such as jobs involving the execution of a single circuit with a given number of shots. Use cases for real-time updates as shown in FIG. 9 can include, e.g., quantum teleportation, quantum error correction (QEC), probabilistic error cancelation (PEC), Pauli twirling, and/or other job types that utilize live parameters.

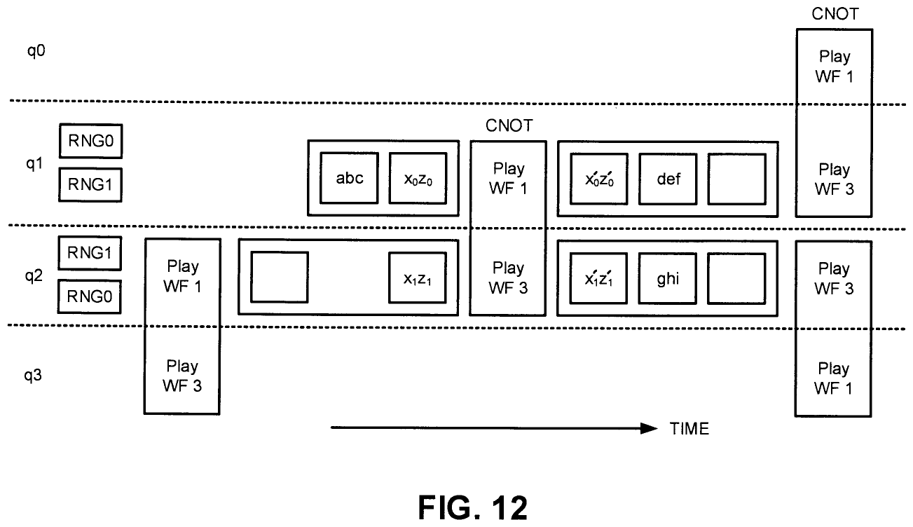

Moving to FIG. 10, an example of near-real-time parameter updates is provided, e.g., in which a control loop for parameter updates occurs between the host system 810 and the control system runtime 912. In the example shown by FIG. 10, the host system 810 can be responsible for setting new parameters and reloading the parameter memory of respective qubit controllers 102 with the new parameters. Depending on implementation, near-real-time parameter updates as shown in FIG. 10 can occur with a latency on the order of tens to hundreds of milliseconds. Near-real-time parameter updates as shown by FIG. 10 can be utilized in use cases such as calibrations, composite executions (e.g., looping), primitives, or the like.

A second example of near-real-time parameter updates is shown by FIG. 11, in which parameter update decisions reside at the SDK runtime 1110 and resulting parameter updates are propagated through the host system 810. Parameter updates performed as shown by FIG. 11 can occur with a latency on the order of seconds, and can be leveraged for use cases such as VQE and/or other post-computed parametric jobs.

Turning next to FIG. 12, another example, non-limiting Pauli twirling operation that can be performed by a qubit controller 202 as shown in FIG. 2 is illustrated. The operation shown by FIG. 12 is similar to the operation shown in FIG. 7 and described above, with the addition of random number generators (RNGs) associated with the affected qubits to facilitate Pauli twirling in hardware. As shown in FIG. 12, the values of X₀Z₀ and X₀′Z₀′ can be sampled via the provided RNGs and merged into the frame update, e.g., in a similar manner to that described above with respect to FIG. 7.

As FIG. 12 further illustrates, by introducing RNGs associated with each qubit, the sampling and frame update operations associated with Pauli twirling can be performed for each qubit without communication between their associated qubit controllers using a shared RNG value. Stated another way, the shared RNG values between the respective qubits can facilitate a shared notion of the frame to be sampled at each of the qubits, which can enable the respective qubit controllers to operate based on that shared notion without performing inter-qubit communication.

Returning now to FIG. 2, by performing twirling in hardware as described herein, the qubit controller 202 can provide various benefits that can improve the performance of a quantum computing system. For instance, hardware-based twirling can enable the non-limiting system 200 to move down to the one shot per circuit limit for twirling, reduce payload sizes higher in the stack, and/or isolate program intent to one circuit that can be submitted to the hardware to be twirled. In conventional twirling, each shot run can necessitate the generation of potentially hundreds to thousands of circuits, which can introduce significant overhead. In contrast, by performing twirling directly in hardware, program parameters that would be used for generation of those circuits can instead be freed for other purposes. As another benefit, hardware-based twirling as described herein can enable full compatibility with classical control flow.

In an embodiment, the qubit controller 202 shown in FIG. 2 can utilize fast gate compression instructions to combine computed frame updates. By way of example, an arbitrary qubit rotation can be expressed using the decomposition described above with respect to FIG. 5, and then random Clifford operations X^{x}^{₁}Z^{z}^{₁} and X^{x}^{₀}Z^{z}^{₀} can be applied to the rotation for purposes of twirling, as shown in the equation below:

$${X}^{{x}_{1}} {Z}^{{z}_{1}} Z ( c ) \cdot \sqrt{X} \cdot Z ( b ) \cdot \sqrt{X} \cdot Z ( a ) {X}^{{x}_{0}} {Z}^{{z}_{0}} .$$

Based on the above representation, a frame update can be applied by the qubit controller 202 without changing the qubit and/or its associated waveforms by applying negations and/or x shifts, e.g., according to the below:

$$Z ( {( - 1 )}^{{x}_{1}} c + ( {x}_{1} ⊕ {z}_{1} ) π ) \cdot \sqrt{X} \cdot Z ( b + ( {x}_{0} ⊕ {x}_{1} ) π ) \cdot \sqrt{X} \cdot Z ( {( - 1 )}^{{x}_{0}} a + ( {x}_{0} ⊕ {z}_{0} ) π ) .$$

By utilizing the above equation, the qubit controller 202 can take the user parameters a, b, and c, modify the phase update values with the twirled parameters by a factor of π, and then add the resulting values to the user phase update. As a result, values associated with an existing frame update in a given program can be modified to effectively create a twirled circuit.

In an embodiment, a fast gate compression instruction associated with the operations described in the above paragraph can accept inputs including user NCO values, e.g., the values a, b, and c above, and parity values that are computed in the hardware, e.g., based on the Paulis that were sampled. Based on these inputs, this instruction can enable the qubit controller 202 to calculate the effective frame updates to be applied on the fly. Thus, in contrast to conventional frame updates in which respective phase updates are encoded into the program itself as fixed immediate values or parameters, the qubit controller 202 can modify the frame update values on the fly in order to mix in the randomly sampled Pauli frame update, e.g., using a special-purpose instruction as described above.

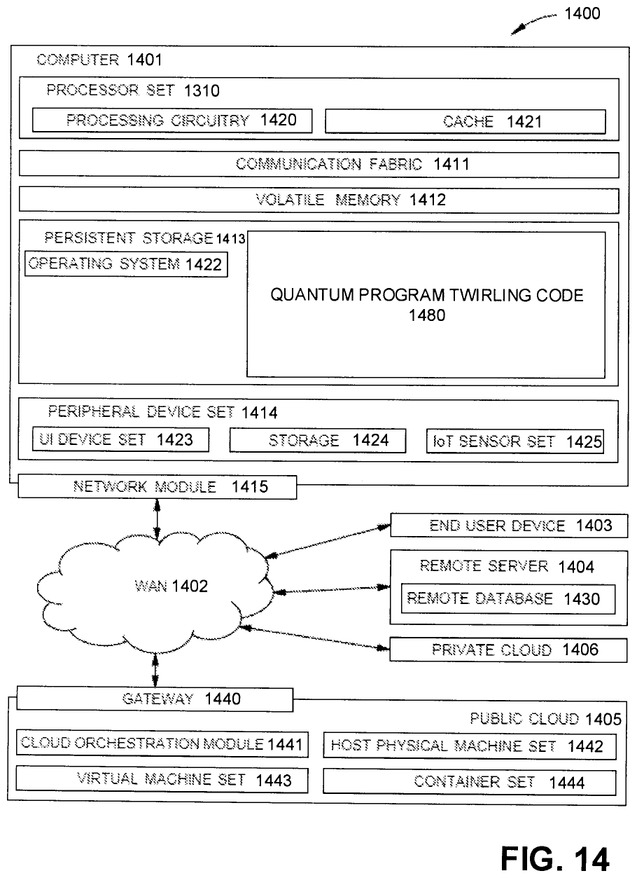

As another summary, referring next to FIG. 13A-13B, illustrated is an example, non-limiting method 1300 that can provide a quantum control system architecture for real-time Pauli twirling of quantum programs in accordance with one or more embodiments described herein, such as the non-limiting system 200 of FIG. 2. While the non-limiting method 1300 is described relative to the non-limiting system 200 of FIG. 2, the non-limiting method 1300 can be applicable also to other systems described herein. Repetitive description of like elements and/or processes employed in respective embodiments is omitted for sake of brevity.

At 1302, the non-limiting method 1300 can comprise determining, by a system operatively coupled to a processor (e.g., initialization component 110), a seed to be applied to a first PRNG (e.g., PRNG 220) associated with a first qubit (e.g., qubit 407) of an input quantum circuit. The seed can be shared with second PRNGs associated with respective second qubits of the input quantum circuit that share a frame with the first qubit. In some embodiments, the seed can be determined at 1302 based on a control message (e.g., control message 130) and/or other suitable information that is provided to the system by a central controller (e.g., quantum control system 120) or similar device. In other embodiments, the seed can be determined at 1302 by deriving the seed from a first clock signal associated with the first PRNG, where the first clock signal is synchronized (e.g., through the use of a clock source 820) with a second clock signal associated with the one or more second PRNGs.

At 1304, the non-limiting method 1300 can comprise sampling, by the system (e.g., sampling component 210), values from the first PRNG that are produced based on the seed determined at 1302.

At 1306, the non-limiting method 1300 can comprise selecting, by the system (e.g., lookup component 212) selected Clifford operations based on a defined mapping between the values sampled at 1304 and the selected Clifford operations.

At 1308, the non-limiting method 1300 can comprise applying, by the system (e.g., Pauli twirling component 112), the selected Clifford operations to the first qubit before and after execution of respective layers of the input quantum circuit, resulting in a first twirled quantum circuit.

At 1310, the non-limiting method 1300 can comprise defining, by the system (e.g., decomposition component 216), a rotation of the first qubit via a series of quantum gates.

At 1312, the non-limiting method 1300 can comprise modifying, by the system (e.g., phase update component 214) and at the respective layers of the input quantum circuit, a phase of the frame of the first qubit according to a function of the selected Clifford operations. The modifying at 1312 can comprise applying a phase rotation to at least one gate of the series of quantum gates defined at 1310.

At 1314, the non-limiting method 1300 can comprise determining, by the system (e.g., initialization component 110), an action time specified in a control message (e.g., control message 130) from a control system (e.g., quantum control system 120). In embodiments in which the seed is received at 1302 from the control system, the control message processed at 1314 can be the same message from which the seed was received at 1302.

At 1316, the non-limiting method 1300 can comprise executing, by the system (e.g., initialization component 110) the input quantum circuit at the action time.

At 1318, the non-limiting method 1300 can comprise determining, by the system (e.g., initialization component 110), whether additional shots associated with the input quantum circuit are to be run. If no, the non-limiting method 1300 can conclude. If yes, the non-limiting method 1300 can instead proceed to 1320.

At 1320, the non-limiting method 1300 can comprise sampling, by the system (e.g., sampling component 210), new values from the first PRNG that are produced based on the seed received at 1302.

At 1322, the non-limiting method 1300 can comprise selecting, by the system (lookup component 212), new selected Clifford operations based on a defined mapping between the values sampled at 1320 and the new selected Clifford operations.

At 1324, the non-limiting method 1300 can comprise applying, by the system (e.g., Pauli twirling component 112), the new selected Clifford operations to the first qubit before and after execution of respective layers of a new instance of the input quantum circuit without reloading the input quantum circuit, resulting in a new twirled quantum circuit. Following 1324, the non-limiting method 1300 can return to 1318.

### ADDITIONAL SUMMARY

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide systems, computer-implemented methods and/or computer program products to facilitate a quantum control system architecture for real-time Pauli twirling of quantum programs. Benefits of the systems, computer-implemented methods and/or computer programs products can include, e.g., the following. Improved quantum circuit error mitigation through the ability to dynamically generate Pauli twirled circuits in hardware within in executing quantum program. Reduced messaging overhead associated with communicating parameters for Pauli twirling. Enabling the communication of a single seed value prior to execution of the circuit instead of a complete set of parameters for Pauli twirling, which can reduce the amount of information communicated during execution. Ensuring precise timing control for operations associated with the input quantum circuit, resulting in improved inter-qubit synchronization. Enabling the space of Clifford operations to be encoded using two-bit values, which can reduce the amount of information generated and/or utilized in connection with selecting an operation. Enabling a Clifford operation to be selected in a simplified manner using random data samples and a mapping function. Improved hardware efficiency associated with Pauli twirling by enabling the use of pre-computed phase updates instead of parameters that are computed individually for each operation. Simplifying qubit phase updates via the ability to encode arbitrary phase updates using a uniform series of gates. Simplifying a phase rotation into a special-purpose instruction that can be implemented efficiently in hardware. Enabling Pauli twirling for multiple shots or instances of a given quantum circuit without requiring reloading or recompilation of the circuit. Other benefits are also possible.

Yet another benefit of the systems, computer-implemented methods and/or computer program products can generally be an improvement in the functioning of a quantum computer. This improvement over existing computerized technologies and/or quantum computerized technologies improves the function of a quantum computer with respect to messaging overhead and/or overall operational efficiency of the quantum computer. As a result, the speed of use, efficiency of use, and/or accuracy and/or precision of outputs produced by one or more qubits of the quantum computer can be increased, e.g., via the improved system efficiency resulting from use of the systems, computer-implemented methods and/or computer program products.

Indeed, in view of the one or more embodiments described herein, a practical application of the one or more systems, computer-implemented methods and/or computer program products described herein can be an enhancement in the ability to accurately write and execute quantum computer programs through the use of processes as provided herein. These processes can be useful in fields of finance, biology, chemistry, materials science, pharmacology and/or drug-delivery using a quantum processor, without being limited thereto. Overall, the one or more systems, computer-implemented methods and/or computer program products described herein can constitute a concrete and tangible technical improvement in the fields of quantum processing and/or quantum dynamics, without being limited thereto.

Furthermore, one or more embodiments described herein can be employed in a real-world system based on the disclosed teachings. For example, one or more embodiments described herein can function in combination with a physical quantum computer having a physical quantum processor. In response to one or more waveforms generated by a waveform generator of the quantum computer, physical quantum qubit hardware of the quantum processor can produce signals and/or changes in state of the qubit hardware, resulting in ability to measure such signals and/or changes in state of the qubit hardware. The measurements, e.g., the measurement outcomes, can be thereafter employed for various inference actions relative to sample quantum data corresponding to one or more quantum circuits having been executed on the quantum computer by way of operation of the waveform generator.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, as compared to existing systems and/or techniques. Systems, computer-implemented methods and/or computer program products providing performance of these processes are of great utility in the fields of quantum circuit operation and/or quantum computing more generally and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically perform quantum circuit encoding, load a quantum register, perform quantum calculations, generate a waveform and/or measure a state of qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: an initialization component that determines a seed to be applied to a first PRNG associated with a first qubit of an input quantum circuit, the seed being shared with one or more second PRNGs associated with respective second qubits of the input quantum circuit that share a frame with the first qubit; and a Pauli twirling component that applies selected Clifford operations to the first qubit before and after execution of respective layers of the input quantum circuit, resulting in a twirled quantum circuit, wherein the selected Clifford operations are selected according to an output of the first PRNG that is produced based on the seed.

The system of the preceding paragraph, wherein the initialization component receives the seed in a control message from a control system prior to execution of the input quantum circuit, and wherein the control message causes the system to execute the input quantum circuit at an action time specified by the control message.

The system of any preceding paragraph, wherein the selected Clifford operations are selected from the group consisting of an identity gate, a Pauli-X gate, a Pauli-Y gate, and a Pauli-Z gate.

The system of any preceding paragraph, wherein the computer executable components further comprise: a sampling component that samples values from the first PRNG; and a lookup component that selects the selected Clifford operations based on a defined mapping between the values and the selected Clifford operations.

The system of any preceding paragraph, wherein the computer executable components further comprise: a phase update component that modifies, at the respective layers of the input quantum circuit, a phase of the frame of the first qubit according to a function of the selected Clifford operations.

The system of any preceding paragraph, wherein the computer executable components further comprise: a decomposition component that defines a rotation of the first qubit via a series of quantum gates, wherein the phase update component modifies the phase of the frame of the first qubit by applying a phase rotation to at least one gate of the series of quantum gates.

The system of any preceding paragraph, wherein an amount of the phase rotation is defined by an instruction provided to the system by a control system.

The system of any preceding paragraph, wherein: the selected Clifford operations are first selected Clifford operations, the Pauli twirling component applies the first selected Clifford operations to the first qubit before and after execution of respective layers of a first instance of the input quantum circuit, resulting in a first twirled quantum circuit, the output of the first PRNG is a first output, and the Pauli twirling component further applies second selected Clifford operations to the first qubit before and after execution of respective layers of a second instance of the input quantum circuit, resulting in a second twirled quantum circuit, the second selected Clifford operations being selected according to a second output of the first PRNG that is produced based on the seed and without reloading the input quantum circuit.

The system of any preceding paragraph, wherein the initialization component derives the seed from a first clock signal associated with the first PRNG, the first clock signal being synchronized with a second clock signal associated with the one or more second PRNGs.

A computer-implemented method, comprising: determining, by a system operatively coupled to a processor, a seed to be applied to a first PRNG associated with a first qubit of an input quantum circuit, the seed being shared with one or more second PRNGs associated with respective second qubits of the input quantum circuit that share a frame with the first qubit; and applying, by the system, selected Clifford operations to the first qubit before and after execution of respective layers of the input quantum circuit, resulting in a twirled quantum circuit, wherein the selected Clifford operations are selected according to an output of the first PRNG that is produced based on the seed.

The computer-implemented method of the preceding paragraph, wherein the determining of the seed further comprises receiving the seed in a control message from the control system prior to execution of the input quantum circuit, and wherein the computer-implemented method further comprises: executing, by the system, the input quantum circuit at an action time specified by the control message.

The computer-implemented method of any preceding paragraph, wherein the selected Clifford operations are selected from the group consisting of an identity gate, a Pauli-X gate, a Pauli-Y gate, and a Pauli-Z gate.

The computer-implemented method of any preceding paragraph, further comprising: sampling, by the system, values from the first PRNG; and selecting, by the system, the selected Clifford operations based on a defined mapping between the values and the selected Clifford operations.

The computer-implemented method of any preceding paragraph, further comprising: modifying, by the system and at the respective layers of the input quantum circuit, a phase of the frame of the first qubit according to a function of the selected Clifford operations.

The computer-implemented method of any preceding paragraph, wherein the selected Clifford operations are first selected Clifford operations, wherein the applying comprises applying the first selected Clifford operations to the first qubit before and after execution of respective layers of a first instance of the input quantum circuit, resulting in a first twirled quantum circuit, wherein the output of the first PRNG is a first output, and wherein the computer-implemented method further comprises: applying, by the system, second selected Clifford operations to the first qubit before and after execution of respective layers of a second instance of the input quantum circuit, resulting in a second twirled quantum circuit, the second selected Clifford operations being selected according to a second output of the first PRNG that is produced based on the seed and without reloading the input quantum circuit.

A computer program product facilitating a process to facilitate real-time Pauli twirling of quantum programs with control flow, the computer program product comprising a computer readable storage medium having program instructions embodied therewith, the program instructions executable by a processor to cause the processor to: determine, by the processor, a seed to be applied to a first PRNG associated with a first qubit of an input quantum circuit, the seed being shared with one or more second PRNGs associated with respective second qubits of the input quantum circuit that share a frame with the first qubit; and apply, by the processor, selected Clifford operations to the first qubit before and after execution of respective layers of the input quantum circuit, wherein the selected Clifford operations are selected according to an output of the first PRNG that is produced based on the seed.

The computer program product of the preceding paragraph, wherein the program instructions are further executable by the processor to cause the processor to: receive, by the processor, the seed in a control message from a control system prior to execution of the input quantum circuit; and execute, by the processor, the input quantum circuit at an action time specified by the control message.

The computer program product of any preceding paragraph, wherein the selected Clifford operations are selected from the group consisting of an identity gate, a Pauli-X gate, a Pauli-Y gate, and a Pauli-Z gate.

The computer program product of any preceding paragraph, wherein the program instructions are further executable by the processor to cause the processor to: sample, by the processor, values from the first PRNG; and select, by the processor, the selected Clifford operations based on a defined mapping between the values and the selected Clifford operations.

The computer program product of any preceding paragraph, wherein the program instructions are further executable by the processor to cause the processor to: modify, at the respective layers of the input quantum circuit, the phase of a frame of the first qubit according to a function of the selected Clifford operations.

### Computing Environment Description

Turning next to FIGS. 14, 15A, and 15B, a detailed description is provided of additional context for the one or more embodiments described herein at FIGS. 1-13.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as quantum program twirling code 1480. In addition to block 1480, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1480, as identified above), peripheral device set 1414 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

PROCESSOR SET 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits.

Computer readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1421 and the other storage media discussed below. The program instructions, and associated data, are accessed by processor set 1410 to control and direct performance of the inventive methods. In computing environment 1400, at least some of the instructions for performing the inventive methods may be stored in block 1480 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid state storage devices. Operating system 1422 may take several forms, such as various known proprietary operating systems or open source Portable Operating System Interface-type operating systems that employ a kernel. The code included in block 1480 typically includes at least some of the computer code involved in performing the inventive methods.

PERIPHERAL DEVICE SET 1414 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

NETWORK MODULE 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401), and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

REMOTE SERVER 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud.

FIG. 15A illustrates a block diagram of an example hybrid computing system 1500 that can facilitate execution of a quantum algorithm. As shown, a client device 1510 may interface with a classical backend 1520 to enable computations with the aid of a quantum system 1530.

Network 1502 may be any combination of connections and protocols that will support communications between the client device 1510, the classical backend 1520, and the quantum system 1530. In an example embodiment, network 1502 may include WAN 1402.

Client device 1510 may be an implementation of computer 1401 or EUD 1403, described in more detail with reference to FIG. 14, configured to operate in a hybrid computing system 1500. In some implementations, the client device 1510 can be utilized to generate quantum application data for use by a quantum control system 120, as shown in FIGS. 1-2 (e.g., as implemented by the classical backend 1520 as described below), and/or other systems.

Client application 1511 may include an application or program code that includes computations requiring a quantum algorithm or quantum operation. In an embodiment, client application 1511 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 1511 may include machine level instructions for performing a quantum circuit, such as OpenQASM. Additionally, user application may be any other high-level interface, such as a graphical user interface, having the underlying object oriented and/or machine level code as described above.

The classical backend 1520 may be an implementation of computer 1401, described in more detail with reference to FIG. 14. In implementations, the classical backend 1520 can be used to provide at least a portion of the functionality of a quantum control system 120 and/or other systems. The classical backend 1520 can have program modules configured to operate in a hybrid computing system 1500. Such program modules for classical backend 1520 may include algorithm preparation 1521, classical computation 1523, and data store 1524.

Algorithm preparation 1521 may be a program or module capable of preparing algorithms contained in client application 1511 for operation on quantum system 1530. Algorithm preparation 1521 may be instantiated as part of a larger algorithm, such as a function call of an API, or by parsing a hybrid classical-quantum computation into aspects for quantum and classical calculation. Algorithm preparation 1521 may additionally compile or transpile quantum circuits that were contained in client application 1511 into an assembly language code for use by the local classical controller 1531 to enable the quantum processor 1533 to perform the logical operations of the circuit on physical structures. During transipilation/compilation an executable quantum circuit in the quantum assembly language may be created based on the calculations to be performed, the data to be analyzed, and the available quantum hardware. In one example embodiment, algorithm preparation 1521 may select a quantum circuit from a library of circuits that have been designed for use in a particular problem. In another example embodiment, algorithm preparation 1521 may receive a quantum circuit from the client application 1511 and may perform transformations on the quantum circuit to make the circuit more efficient, or to fit the quantum circuit to available architecture of the quantum processor 1533. Additionally, algorithm preparation 1521 may prepare classical data from data store 1524, or client application 1511, as part of the assembly language code for implementing the quantum circuit by the local classical controller 1531. Algorithm preparation 1521 may additionally set the number of shots (i.e., one complete execution of a quantum circuit) for each circuit to achieve a robust result of the operation of the algorithm. Further, algorithm preparation 1521 may update, or re-compile/re-transpile, the assembly language code based on parallel operations occurring in classical computing resource 1523 or results received during execution of the quantum calculation on quantum system 1530. Additionally, algorithm preparation 1521 may determine the criterion for convergence of the quantum algorithm or hybrid algorithm.

Error Suppression/Mitigation 1522 may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 1532 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 1523 may be a program or module capable of performing classical (e.g., binary, digital) calculations contained in client application 1511. Classical calculations may include formal logical decisions, AI/ML algorithms, floating point operations, and/or simulation of Quantum operations.

Data store 1524 may be a repository for data to be analyzed using a quantum computing algorithm, as well as the results of such analysis. Data store 1524 may be an implementation of storage 1424 and/or remote database 1430, described in more detail with reference to FIG. 14, configured to operate in a hybrid computing system 1500.

The quantum system 1530 can be any suitable set of components capable of performing quantum operations on a physical system. In various implementations, the quantum system 1530 can be utilized to implement at least a portion of the functionality of the quantum system 401 described above, e.g., with respect to FIGS. 1-2, elements of the quantum system 401 such as qubit controllers 102/202, and/or other systems. In the example embodiment depicted in FIG. 15, quantum system 1530 includes a local classical controller 1531, a classical-quantum interface 1532, and quantum processor 1533. In some embodiments, all or part of each of the local classical controller 1531, a classical-quantum interface 1532, and quantum processor 1533 may be located in a cryogenic environment to aid in the performance of the quantum operations. In an embodiment, classical backend 1520 and quantum system 1530 may be co-located to reduce the communication latency between the devices.

Local classical controller 1531 may be any combination of classical computing components capable of aiding a quantum computation, such as executing a one or more quantum operations to form a quantum circuit, by providing commands to a classical-quantum interface 1532 as to the type and order of signals to provide to the quantum processor 1533. Local classical controller 1531 may additionally perform other low/no latency functions, such as error correction, to enable efficient quantum computations. Such digital computing devices may include processors and memory for storing and executing quantum commands using classical-quantum interface 1532. Additionally, such digital computing devices may include devices having communication protocols for receiving such commands and sending results of the performed quantum computations to classical backend 1520. Additionally, the digital computing devices may include communications interfaces with the classical-quantum interface 1532. In an embodiment, local classical controller 1531 may include all components of computer 1401, or alternatively may be individual components configured for specific quantum computing functionality, such as processor set 1410, communication fabric 1411, volatile memory 1412, persistent storage 1413, and network module 1415.

Classical-quantum interface 1532 may be any combination of devices capable of receiving command signals from local classical controller 1531 and converting those signals into a format for performing quantum operations on the quantum processor 1533. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 1532 may be capable of converting signals received from the quantum processor 1533 into digital signals capable of processing and transmitting by local classical controller 1531 and classical backend 1520. Such signals may include qubit state readouts. Devices included in classical-quantum interface 1532 may include, but are not limited to, digital-to-analog converters, analog-to-digital converters, waveform generators, attenuators, amplifiers, filters, optical fibers, and lasers. To the above ends, the classical-quantum interface 1532 can include qubit controllers (e.g., qubit controllers 102/202 as described above with respect to FIGS. 1-2 and/or 12) and/or other components that facilitate interactions between the local classical controller 1531 and respective qubits associated with the quantum processor 1533, e.g., as described below.

Quantum processor 1533 may be any hardware capable of using quantum states to process information. Such hardware may include a collection of qubits, mechanisms to couple/entangle the qubits, and any required signal routings to communicate between qubits or with classical-quantum interface 1532 in order to process information using the quantum states. Such qubits may include, but are not limited to, charge qubits, flux qubits, phase qubits, spin qubits, and trapped ion qubits, or any other suitable qubit structures. The architecture of quantum processor 1533, such as the arrangement of data qubits, error correcting qubits, and the couplings amongst them, may be a consideration in performing a quantum circuit on quantum processor 1533.

Referring now to FIG. 15B, a block diagram is depicted showing an example architecture, and data transmission, of hybrid computation system 1550 employed using a cloud architecture for classical backend 1520. Hybrid computation system 1550 receives an algorithm containing a computation from a client application 1511 of client device 1510. Upon receipt of the algorithm and request from client application 1511, hybrid computation system 1550 instantiates a classical computing node 1560 and a quantum computing node 1570 to manage the parallel computations. The classical computing node 1560 may include one or more classical computers capable of working in tandem (e.g., utilizing a cloud computing environment). For example, classical computing node 1560 may include an execution orchestration engine 1561, one or more classical computation resources 1523, and a result data store 1524. The backend quantum runtime system may include a combination of classical and quantum computing components acting together to perform quantum calculations on quantum hardware including, for example, one or more quantum systems 1530. The quantum computing node 1570 may include a quantum runtime application 1571 and one or more quantum systems 1530.

The client application 1511 may include programing instructions to perform quantum and classical calculations. In an embodiment, client application 1511 may be in a general purpose computing language, such as an object oriented computing language (e.g., Python®), that may include classical and quantum functions and function calls. This may enable developers to operate in environments they are comfortable with, thereby enabling a lower barrier of adoption for quantum computation.

The execution orchestration engine 1561, in using algorithm preparation 1521, may parse the client application 1511 into a quantum logic/operations portion for implementation on a quantum computing node 1570, and a classical logic/operations portion for implementation on a classical node 1560 using a classical computation resource 1523. In an embodiment, parsing the client application 1511 may include performing one or more data processing steps prior to operating the quantum logic using the processed data. In an embodiment, parsing the client application 1511 may including segmenting a quantum circuit into portions that are capable of being processed by quantum computing node 1570, in which the partial results of each of the segmented quantum circuits may be recombined as a result to the quantum circuit. Execution orchestration engine 1561 may parse the hybrid algorithm such that a portion of the algorithm is performed using classical computation resources 1523 and a session of quantum computing node 1570 may open to perform a portion of the algorithm. Quantum runtime application 1571 may communicate, directly or indirectly, with classical computation resources 1523 by sending parameters/information between the session to perform parallel calculations and generate/update instructions of quantum assembly language to operate quantum system 1530, and receiving parameters/information/results from the session on the quantum system 1530. Following the parsing of the hybrid algorithm for calculation on quantum computing node 1570 and classical computing node 1560, the parallel nodes may iterate the session to convergence by passing the results of quantum circuits, or partial quantum circuits, performed on quantum system 1530 to classical computing resource 1523 for further calculations. Additionally, runtime application 1571, using algorithm preparation 1521, may re-parse aspects of the hybrid algorithm to improve convergence or accuracy of the result. Such operation results, and progress of convergence, may be sent back to client device 1510 as the operations are being performed. By operating execution orchestration engine 1561 in a cloud environment, the environment may scale (e.g., use additional computers to perform operations necessary) as required by the client application 1511 without any input from the creators/implementors of client application 1511. Additionally, execution orchestration engine 1561, while parsing the client application 1511 into classical and quantum operations, may generate parameters, function calls, or other mechanisms in which classical computation resource 1523 and quantum computing node 1570 may pass information (e.g., data, commands) between the components such that the performance of the computations enabled by client application 1511 is efficient.

Classical computation resources 1523 may perform classical computations (e.g., formal logical decisions, AI/ML algorithms, floating point operations, simulation of Quantum operations) that aid/enable/parallelize the computations instructed by client application 1511. By utilizing classical computation resources 1523 in an adaptively scalable environment, such as a cloud environment, the environment may scale (e.g., use additional computers to perform operations necessary including adding more classical computation resources 1523, additional quantum systems 1530, and/or additional resources of quantum systems 1530 within a given quantum computing node 1570) as required by the client application 1511 without any input from the creators/implementors/developers of client application 1511, and may appear seamless to any individual implementing client application 1511 as there are no required programming instructions in client application 1511 needed to adapt to the classical computation resources 1523. Thus, for example, such scaling of quantum computing resources and classical computing resources may be provided as needed without user intervention. Scaling may reduce the idle time, and thus reduce capacity and management of computers in classical computing node 1560.

Result data store 1524 may store, and return to client device 1510, states, configuration data, etc., as well as the results of the computations of the client application 1511.

Implementation of the systems described herein may enable hybrid computing system 1500, through the use of quantum system 1530, to process information, or solve problems, in a manner not previously capable. The efficient parsing of the quantum or hybrid algorithm into classical and quantum segments for calculation may achieve efficient and accurate quantum calculations from the quantum system 1530 for problems that are exponentially difficult to perform using classical backend 1520. Additionally, the quantum assembly language created by classical backend 1520 may enable quantum system 1530 to use quantum states to perform calculations that are not classically efficient or accurate. Such improvement may reduce the classical resources required to perform the calculation of the quantum or hybrid algorithm, by improving the capabilities of the quantum system 1530.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an initialization component that determines a seed to be applied to a first pseudorandom number generator (PRNG) associated with a first qubit of an input quantum circuit, the seed being shared with one or more second PRNGs associated with respective second qubits of the input quantum circuit that share a frame with the first qubit; and
a Pauli twirling component that applies selected Clifford operations to the first qubit before and after execution of respective layers of the input quantum circuit, resulting in a twirled quantum circuit, wherein the selected Clifford operations are selected according to an output of the first PRNG that is produced based on the seed.

2. The system of claim 1, wherein the initialization component receives the seed in a control message from a control system prior to execution of the input quantum circuit, and wherein the control message causes the system to execute the input quantum circuit at an action time specified by the control message.

3. The system of claim 1, wherein the selected Clifford operations are selected from the group consisting of an identity gate, a Pauli-X gate, a Pauli-Y gate, and a Pauli-Z gate.

4. The system of claim 1, wherein the computer executable components further comprise:
a sampling component that samples values from the first PRNG; and
a lookup component that selects the selected Clifford operations based on a defined mapping between the values and the selected Clifford operations.

5. The system of claim 1, wherein the computer executable components further comprise:
a phase update component that modifies, at the respective layers of the input quantum circuit, a phase of the frame of the first qubit according to a function of the selected Clifford operations.

6. The system of claim 5, wherein the computer executable components further comprise:
a decomposition component that defines a rotation of the first qubit via a series of quantum gates, wherein the phase update component modifies the phase of the frame of the first qubit by applying a phase rotation to at least one gate of the series of quantum gates.

7. The system of claim 6, wherein an amount of the phase rotation is defined by an instruction provided to the system by a control system.

8. The system of claim 1, wherein:
the selected Clifford operations are first selected Clifford operations,
the Pauli twirling component applies the first selected Clifford operations to the first qubit before and after execution of the respective layers of a first instance of the input quantum circuit, resulting in a first twirled quantum circuit,
the output of the first PRNG is a first output, and
the Pauli twirling component further applies second selected Clifford operations to the first qubit before and after execution of the respective layers of a second instance of the input quantum circuit, resulting in a second twirled quantum circuit, the second selected Clifford operations being selected according to a second output of the first PRNG that is produced based on the seed and without reloading the input quantum circuit.

9. The system of claim 1, wherein the initialization component derives the seed from a first clock signal associated with the first PRNG, the first clock signal being synchronized with a second clock signal associated with the one or more second PRNGs.

10. A computer-implemented method, comprising:
determining, by a system operatively coupled to a processor, a seed to be applied to a first pseudorandom number generator (PRNG) associated with a first qubit of an input quantum circuit, the seed being shared with one or more second PRNGs associated with respective second qubits of the input quantum circuit that share a frame with the first qubit; and
applying, by the system, selected Clifford operations to the first qubit before and after execution of respective layers of the input quantum circuit, resulting in a twirled quantum circuit, wherein the selected Clifford operations are selected according to an output of the first PRNG that is produced based on the seed.

11. The computer-implemented method of claim 10, wherein the determining of the seed further comprises receiving the seed in a control message from a control system prior to execution of the input quantum circuit, and wherein the computer-implemented method further comprises:
executing, by the system, the input quantum circuit at an action time specified by the control message.

12. The computer-implemented method of claim 10, wherein the selected Clifford operations are selected from the group consisting of an identity gate, a Pauli-X gate, a Pauli-Y gate, and a Pauli-Z gate.

13. The computer-implemented method of claim 10, further comprising:
sampling, by the system, values from the first PRNG; and
selecting, by the system, the selected Clifford operations based on a defined mapping between the values and the selected Clifford operations.

14. The computer-implemented method of claim 10, further comprising:
modifying, by the system and at the respective layers of the input quantum circuit, a phase of the frame of the first qubit according to a function of the selected Clifford operations.

15. The computer-implemented method of claim 10, wherein the selected Clifford operations are first selected Clifford operations, wherein the applying comprises applying the first selected Clifford operations to the first qubit before and after execution of the respective layers of a first instance of the input quantum circuit, resulting in a first twirled quantum circuit, wherein the output of the first PRNG is a first output, and wherein the computer-implemented method further comprises:
applying, by the system, second selected Clifford operations to the first qubit before and after execution of the respective layers of a second instance of the input quantum circuit, resulting in a second twirled quantum circuit, the second selected Clifford operations being selected according to a second output of the first PRNG that is produced based on the seed and without reloading the input quantum circuit.

16. A computer program product facilitating a process to facilitate real-time Pauli twirling of quantum programs with control flow, the computer program product comprising a computer readable storage medium having program instructions embodied therewith, the program instructions executable by a processor to cause the processor to:
determine, by the processor, a seed to be applied to a first pseudorandom number generator (PRNG) associated with a first qubit of an input quantum circuit, the seed being shared with one or more second PRNGs associated with respective second qubits of the input quantum circuit that share a frame with the first qubit; and
apply, by the processor, selected Clifford operations to the first qubit before and after execution of respective layers of the input quantum circuit, wherein the selected Clifford operations are selected according to an output of the first PRNG that is produced based on the seed.

17. The computer program product of claim 16, wherein the program instructions are further executable by the processor to cause the processor to:
receive, by the processor, the seed in a control message from a control system prior to execution of the input quantum circuit; and
execute, by the processor, the input quantum circuit at an action time specified by the control message.

18. The computer program product of claim 16, wherein the selected Clifford operations are selected from the group consisting of an identity gate, a Pauli-X gate, a Pauli-Y gate, and a Pauli-Z gate.

19. The computer program product of claim 16, wherein the program instructions are further executable by the processor to cause the processor to:
sample, by the processor, values from the first PRNG; and
select, by the processor, the selected Clifford operations based on a defined mapping between the values and the selected Clifford operations.

20. The computer program product of claim 16, wherein the program instructions are further executable by the processor to cause the processor to:
modify, at the respective layers of the input quantum circuit, a phase of the frame of the first qubit according to a function of the selected Clifford operations.
